(19) United States
(12) Patent Application Publication
(10) Pub. No.: US 2023/0203774 A1
(43) Pub. Date: Jun. 29, 2023

(54) DEVICES AND METHODS FOR INSTALLING PILES INTO THE GROUND OR SEABED

(71) Applicant: Heerema Marine Contractors Nederland SE, Leiden (NL)

(72) Inventors: Marco HUISMAN, Leiden (NL); Marius Gabriël OTTOLINI, Leiden (NL); Paul Antonius Alphonsus GEENE, Leiden (NL); Michael John BROWN, Leiden (NL); Benjamin Pierre Jacques CERFONTAINE, Leiden (NL); Yaseen Umar SHARIF, Leiden (NL)

(21) Appl. No.: 17/917,590

(22) PCT Filed: Apr. 8, 2021
(86) PCT No.: PCT/EP2021/059219

§ 371 Date: Oct. 7, 2022

(30) Foreign Application Priority Data
Apr. 8, 2020 (NL) 2025306

(51) Int. Cl. E02D 11/00; E02D 13/04; E02D 15/08; E02D 27/52

(52) U.S. Cl. CPC E02D 11/00; E02D 13/04; E02D 15/08; E02D 27/525

(57) ABSTRACT

The present invention relates to a support structure for supporting a top structure, in particular a wind turbine, above the ground or a seabed, the support structure comprising: one single support pile having a length and a first outer diameter, the one single support pile comprising an upper part configured and intended to extend above the ground or the seabed, wherein the upper part of the support pile is configured to be connected to the top structure; a lower part configured to be in contact with the ground or seabed, wherein the support pile is configured to exert an upward vertical force on the top structure in order to carry the top structure; a plurality of foundation guides connected to the lower part of the single support pile, each foundation guide having an opening extending in a direction of the support pile.

### FIELD OF THE INVENTION

The present invention relates in a first aspect to a device for pushing at least five piles into or pulling at least five piles out of the ground or a seabed in a polygonal configuration. Devices for pushing piles into the ground are known in the field of the art.

In a second aspect the present invention relates to a helical pile for installation into the ground or seabed, and a method for installing said helical pile.

In a third aspect the present invention relates to a support structure and a support assembly for supporting a top structure above the ground or a seabed, and to a method for installing said support assembly.

### BACKGROUND OF THE INVENTION

Offshore structures are generally grounded to the seabed with large diameter piles. The piles may be installed through the legs of the structure, so called main piles, or may be installed adjacent to the structure and connected with pile sleeves, so called skirt piles, to the structure. In order to insert these piles into the seabed, hydraulic impact hammers are typically used. The impact of the hydraulic hammer on the pile during a blow radially expands the pile. This expansion in turn results into a pressure wave in the water and soil column.

The noise generated by the pressure wave may be harmful for marine animals, in particular mammals. In some areas regulatory bodies limit the allowed sound levels. Such regions are for instance Germany, where the allowed sound levels are limited to 160 dB SEL5% at 750 m. In order to reduce the sound levels bubble curtains can be deployed prior to installation. These curtains are hoses with holes which lay on the seabed. Air is blown through these hoses, which escapes through the holes. Due to the difference in impedance between the air bubbles and the seawater part of the pressure wave is reflected and energy is dissipated reducing the noise levels significantly.

In order to blow enough air from the bubble curtain, many compressors are required. These are typically positioned on an auxiliary vessel. This is an expensive operation and has a large carbon footprint. Furthermore, the noise during pile driving is only reduced, never fully mitigated. Finally, these bubble curtains only work effectively in shallow water depths and become less efficient at larger depths. Therefore a silent alternative would be preferred both from a sustainability and technical perspective.

A further disadvantage of hammering piles into the ground or seabed is that the shockwaves typically are so strong that they damage electronic equipment which could be used to measure the position and orientation (inclination) of the piles.

There are several options to silently install piles. Typical examples are screw piles, or helical piles (hereafter helical piles) installed by torque or piles which are pushed into the ground. The push-in pile is often used on land where multiple piles are installed at the same time. One pile is pushed down while the other piles are used as a reaction force. These piles are installed in one line, to form a row. In the present invention, it was recognized that this is not economical for offshore piles, because the distance between the outermost pile and the jacket would become too large. Currently, there is no viable technology available to drive piles into the seabed in a silent manner.

On land, hammering piles into the ground is common technology and widely used for foundations of buildings and in general structures. However, similar issues apply with regard to noise. The hammering has a disadvantage in that a lot of noise is generated, which provides serious inconvenience to people in the surrounding. The hammering may also form a cause of damage to other buildings, in particular by causing cracks in other buildings.

As indicated above, systems for pushing piles into the ground in a silent matter exist. However, such systems generally have a limitation that the piles need to be positioned in a row. Furthermore, these systems generally require a separate reaction frame for the first few piles, because the system requires a support position in order to be able to start working. Only after a few piles are inserted into the ground, the reaction frame is no longer necessary.

Another system for silently driving piles into the ground exists. This system is applied by a British company called Dawson, called a Dawson system. With this system, at least five interlocked sheet piles can be driven into the ground. See the website of this company: http://www.dcpuk.com/products_press.html. This system is considered to form the closest prior art for the present invention.

It was recognized in the present invention that a disadvantage of this Dawson system is that the Dawson system is not capable of driving regular tubular piles into the ground. In the Dawson system, the piles needs to be interlocked, and for this reason need to have a specific design which allows for the interlocking of the piles. Such specially made piles are quite costly.

Other systems for driving piles into the ground in a silent manner also exist. For instance, systems exist for driving piles having a helical shape into the ground. This is essentially screwing a pile into the ground. Although these systems work, the piles need to be specifically designed and manufactured, and are quite costly.

Other systems exist which are based on vibrating piles into the ground. Such systems have a specific disadvantage that the vibrations may also cause inconvenience to people in the surroundings and may be a cause of damage to surrounding buildings. Furthermore, these systems do not work under all circumstances.

The above mentioned helical piles are beneficial from a sound point of view. The installation of helical piles causes less noise than hammering piles into the ground. A disadvantage of the presently available helical piles is that the tension capacity when installed is lower than desired.

The offshore structures usually comprise a support structure and a top structure. The support structure, or foundation, are generally of a monopile type or a jacket type. This is especially the case for wind turbines where monopiles are used as they are considerably easier to fabricate and cheaper to make than jacket type foundations.

With ever increasing water depths the use of monopiles is deemed less favourable for various reasons.

A first reason is that an increase in water depth also means an increase of the required length of the monopile. Secondly the increase in water depth drives the diameter and base requirements, as with an increase in distance between the seabed to the top of the wind turbine the overturning moment on the foundation increases. In general it can be concluded that with increasing turbine size together with increasing water depths, the diameter and length of monopiles will increase. Where some time ago diameters of 8 meter where considered large in size, currently diameters of 12 meters are considered.

Drawbacks of increasing monopile size are experienced in multiple stages before getting a wind turbine foundation operational. This includes fabrication, storage, transport, handling and installation into the seabed.

Temporarily storing the large monopiles before shipping creates additional handling operations as quayside area is typically limited and expensive. Transferring the large monopiles on a barge or installation vessel poses problems as typical yard equipment such as cranes are rapidly reaching their maximum lifting capacity together with their maximum lifting height and reach.

Once offshore, the large monopiles need to be upended, because they are transported horizontally. The upending is becoming increasingly difficult, because of the large dimensions and weight of the monopiles. During installation of the large monopiles increasing sizes of hammers are required which currently do not exist. Larger hammers would also result in more noise during hammering.

An important disadvantage of the large monopiles is that they are difficult to remove when the monopile has reached its end of life. Cutting the monopile just below the mudline means that a large portion of the steel would remain under ground.

Jackets may overcome some of the drawbacks of the large monopiles, but jackets have disadvantages as well.

Jackets are typically installed on top of pre or post installed smaller piles. This has the benefit that the noise levels are reduced, because smaller piles may require less energy input. A drawback here are the additional steps required to install all the smaller piles together with creating the, usually permanent, connection between the smaller piles and the jacket.

A jacket type structure tends to be expensive to build and transport due to its footprint and complex construction. A benefit of the large footprint is a reduction in required lateral capacity opposed to a monopile, which allows for the smaller piles. Jackets are also better suited to counter the overturning moment.

### OBJECT OF THE INVENTION

It is an object of the invention to provide a device for pushing at least five piles into the ground.

It is an object of the invention to provide a helical pile and a method for installing a helical pile which provides a higher tension capacity when installed, in particular while maintaining the compression capacity of the helical pile.

It is an object of the invention to overcome the drawbacks of the ever increasing dimensions of monopiles.

### SUMMARY OF THE INVENTION

### First Aspect

In order to achieve at least one objective, the present invention provides in a first aspect a device for pushing at least five piles into or pulling at least five piles out of the ground or a seabed, wherein in top view at least a number of the at least five piles define a polygonal configuration, wherein any of the remaining at least five piles are located within the polygon, the device comprising:
a bridge assembly which when seen in top view defines at least five connecting locations,
at least five pile connection assemblies via which in use each of the at least five piles is connected to the bridge assembly, wherein each pile connection assembly comprises:
   an actuator which extends downward from the respective connecting location, wherein each actuator comprises an upper actuator part and a lower actuator part, wherein the upper actuator part is connected to the bridge assembly, wherein the actuator is configured to
      extend in order to move the lower actuator part downward relative to the upper actuator part and/or
      retract in order to move the lower actuator part upward relative to the upper actuator part,
   a pile connector connected to the lower actuator part, wherein each pile connector is configured to be connected to an upper part of a pile which is to be pushed into or pulled out of the ground or seabed, wherein the pile connector is configured to move downward or upward relative to the upper actuator part together with the associated lower actuator part during the respective extension or retraction,
a control device configured for alternately pushing or pulling at least one of the at least five piles over a distance into or out of the ground or seabed by applying a vertical force via the associated actuator to the at least one pile which is being pushed into or pulled out of the ground or seabed.

The present invention is based on the general idea that in order to push one pile into the ground, a push force (or compression force) is provided via an actuator connected to the bridge assembly. This push force results in a reaction force of the pile into the bridge assembly. This principle is reversed for pulling piles out of the ground.

An advantage of the invention is that the device can be “stand alone”. In other words, the device does not generate external loads as land based systems generally do, which external loads have to be carried by a separate crane or structure or foundation.

Another advantage of the device according to the invention is that, in contrast to piles that are installed by pile driving, measurement tools can remain on the equipment. This is normally not possible as the measurement system cannot survive the blows from the hammer. This allows direct read-out of the depths and orientations of the independent piles and/or the tool itself and of the loads which are exerted on the piles.

An advantage of at least five piles over fewer than five piles is redundancy in case one of the actuators fails, or if for example the pile connector fails. Then it is still possible to continue by retracting all but the failed actuator. Also there is a lower chance of unintentionally pulling one of the piles out, because more piles provide a higher pulling capacity. In addition, at least five piles allow for pushing in two piles simultaneously, resulting in a possible installation cycle of three steps. This provides a faster installation compared to a device configured to install four piles, because said four piles can only be installed one by one, resulting in a cycle of four steps.

In an embodiment of the device, the control device is configured for regulating at least the vertical force which is exerted by the actuator associated with the pile which is being pushed in or pulled out and/or at least the vertical forces which are exerted by at least two of the remaining actuators on associated remaining, stationary piles, in order to have the at least one pile which is pushed into or pulled out of the ground or seabed receive a greater vertical force than each of the remaining piles.

For the actuators stationary means not retracting and not extending. With vertical forces the absolute forces are meant. Hence, a negative pull force and positive push force are both considered a vertical force. For the piles stationary means that the piles are not being pushed in or pulled out.

Controlling the force of one or more actuators allows for measuring the pile capacity during installation. It also provides a direct control over the load applied to one or more piles thus providing more certainty and reliability to the installation process. Thirdly the force control provides direct feedback on issues when for example the actuator breaks down during use.

In an embodiment of the device, the control device is configured for alternately pushing at least one of the at least five piles over a distance into the ground or seabed by alternately:
having at least one of the actuators associated with the at least one pile being pushed in extend, and/or by
keeping at least one actuator associated with the at least one pile being pushed in substantially stationary while retracting at least three of the remaining actuators, and/or by
keeping at least one actuator associated with the pile being pushed in substantially stationary while extending at least two opposite actuators, thereby pivoting the bridge assembly about a pivot axis extending between said at least one actuator and said at least two opposite actuators.

The first option of alternately extending at least one of the actuators is the simplest. The second and third option provide flexibility to the device.

In an embodiment of the device, the control device is configured for alternately pushing at least one of the at least five piles over a distance into the ground or seabed by alternately:
having at least one of the actuators extend, wherein the control device is configured for regulating at least the vertical force which is exerted by the at least one actuator during the extension thereof in order to let the at least one pile which is pushed into the ground or seabed receive a greater vertical force than each of the remaining piles, and/or by
keeping at least one actuator substantially stationary while retracting at least three of the remaining actuators, wherein the control device is configured for regulating at least the vertical force which is exerted by the at least three retracting actuators in order to let the at least one pile corresponding to the substantially stationary actuator receive a greater vertical force than each of the remaining, stationary piles, and/or by
keeping at least one actuator which is associated with the pile being pushed in substantially stationary while extending at least two opposite actuators, thereby pivoting the bridge assembly about a pivot axis extending between said at least one actuator and said at least two opposite actuators, wherein the control device is configured for regulating at least the vertical force of the at least two opposite extending actuators in order to have the at least one pile being pushed in receive a greater vertical force than each of the remaining, stationary piles for pushing the at least one pile into the ground or seabed.

In an embodiment of the device, the at least one actuator which is associated with the at least one pile which is being pushed into the ground or seabed transfers the exerted vertical push force into the bridge assembly and wherein said push force is transferred at least partially from the bridge assembly as a tension force into at least two of the remaining, stationary piles via the respective pile connection assemblies.

In an embodiment of the device, the polygonal configuration defines a polygon with angles between 90-180 degrees.

In an embodiment of the device, when seen in top view the pile connection assemblies are arranged on a circle or an ellipse. This embodiment provides a clearer load distribution.

In an embodiment of the device, the pile connection assemblies are arranged equidistantly on a circumscribed circle or circumscribed ellipse of the polygon. This embodiment allows for a more clear load distribution. In particular for the circle, because the load distribution can be identical for each pile being pushed in.

In an embodiment of the device, the polygonal configuration is an irregular polygon.

In an embodiment of the device, all piles define the polygon configuration.

In an embodiment of the device, the pivot axis extends through two opposing actuators located between the at least one actuator associated with the pile being pushed in and the at least two opposite extending actuators, wherein the two opposing actuators are configured to be kept stationary during pushing of the at least one pile.

In an embodiment of the device, the control device is configured to keep a sum of the positive, vertical push forces and the negative, vertical pull forces of the actuators substantially zero during the push in of the at least one pile.

In an embodiment of the device, an equilibrium point is defined within the polygon, wherein the control device is configured to keep a sum of the moments applied by the actuators about said equilibrium point substantially zero.

In an embodiment the device comprises at least six connecting locations and six corresponding pile connection assemblies, the device being configured to alternately push at least two piles of the at least six piles into the ground or into the seabed simultaneously. This embodiment provides a fast installation as fewer steps are required, i.e. three steps.

In an embodiment of the device, the at least one or two actuators which is/are associated with the at least one or two piles which is/are being pushed into the ground or seabed transfers the exerted vertical push force into the bridge assembly and wherein said push force is transferred at least partially from the bridge assembly as a bending moment into at least two or three of the remaining, stationary piles via the respective pile connection assemblies.

In an embodiment of the device, each pile connection assembly comprises a sliding assembly which is rigidly connected to the bridge assembly, wherein the sliding assembly comprises a sleeve and one or more gripper actuators which can be switched between a gripping state and a released state, wherein:
in the released state the pile and/or pile connector can slide through the sleeve,
in the gripping state the sleeve is rigidly connected to the pile and/or pile connector, allowing a tension force and a bending moment to be transferred from the bridge assembly into the pile which is in the sleeve.

In an embodiment of the device, the pile connection assemblies are rigidly connected to one another via a base frame which is positioned below the bridge assembly and which is rigidly connected to the bridge assembly via at least one column, wherein the sliding assemblies are connected to the base frame.

In an embodiment of the device, in top view the bridge assembly has a circular or polygonal shape and comprises a central opening, wherein the bridge assembly extends around said central opening.

In an embodiment the device is configured for pushing piles into the ground or seabed which are not interlocked.

In an embodiment the device is configured for pushing piles which are positioned at a horizontal distance from one another and do not contact one another.

In an embodiment of the device, each pile connector comprises an insertable part which is configured to be inserted into an upper part of a tubular pile.

In an embodiment of the device, each pile connector comprises one or more gripper actuators to grip the upper part of the tubular piles.

In an embodiment the device comprises exactly six connecting assemblies and exactly six pile connectors, wherein the six pile connectors are arranged in a hexagonal configuration.

In an embodiment the device is configured to drive all piles vertically into the ground or seabed, wherein in particular all actuators and all pile connectors are oriented vertically.

In an embodiment of the device, a spacing distance between the pile connectors is approximately 0.5 times the diameter of the piles configured to be connected thereto.

In an embodiment of the device, a spacing distance between the pile connectors is 2 times or less of the diameter of the piles configured to be connected thereto.

In an embodiment of the device, a spacing distance between the pile connectors is between 2 and 4 times the diameter of the piles configured to be connected thereto.

In an embodiment of the device, each pile connection assembly is connected to the bridge assembly via a hinge.

In an embodiment of the device, the hinge has a hinge axis which extends perpendicular to the bisector of the associated corner of the polygon.

In an embodiment of the device, the hinge is of the ball joint type.

The present invention further relates to a method of pushing at least five, in particular at least six piles into the ground or into a seabed, the method comprising:
positioning the at least five piles on the ground or on a seabed, and connecting the device according to the first aspect of the invention to the upper parts of the piles, wherein each pile connection assembly is connected to an associated pile,
alternately pushing at least one of the at least five piles over a distance into the ground or seabed by applying a vertical force via the associated actuator to the at least one pile which is being pushed into the ground or seabed.

In an embodiment of the method, the at least one of the at least five piles or at least two of the at least six piles are alternately pushed into the ground or seabed by:
extending the at least one or at least two actuators which are associated with the at least one or at least two piles, and/or by
keeping at least one or at least two actuators associated with the at least one or at least two piles being pushed in substantially stationary while retracting at least three or at least four of the remaining actuators, and/or by
keeping at least one or at least two actuators associated with the at least one or at least two piles being pushed in substantially stationary while extending at least two opposite actuators, thereby pivoting the bridge assembly about a pivot axis extending between said at least one actuator and said at least two opposite actuators,

In an embodiment of the method, the at least one of the at least five piles or at least two of the at least six piles are alternately pushed into the ground or seabed by:
alternately pushing at least one of the at least five piles or at least two of the at least six piles over a distance into the ground or seabed by
   extending the actuator or actuators which are associated with said at least one or at least two piles, wherein during the extension the control device regulates at least the vertical force exerted by the actuator or actuators which extend and the vertical force exerted by at least three of the remaining actuators in order to let the pile which is pushed into the ground or seabed receive a greater vertical force than each of the at least three remaining, stationary piles, and/or by
   keeping at least one or at least two actuators substantially stationary while retracting at least three or at least four of the remaining actuators, wherein during the retraction the control device regulates at least the vertical force which is exerted by the at least one or at least two substantially stationary actuators and the vertical force exerted by the at least three or at least four retracting actuators in order to let the at least one or at least two piles corresponding to the at least one or at least two substantially stationary actuators receive a greater vertical force than each of the remaining, stationary piles for pushing the at least one or at least two piles associated with the at least one or at least two substantially stationary actuators into the ground or seabed, and/or by
   keeping at least one or at least two actuators which are associated with the at least one or at least two piles being pushed in substantially stationary while extending at least two opposite actuators, thereby pivoting the bridge assembly about a pivot axis extending between said at least one actuator and said at least two opposite actuators, wherein the control device is configured for regulating at least the vertical force of the at least two opposite extending actuators in order to have the at least one pile being pushed in receive a greater vertical force than each of the remaining, stationary piles for pushing the at least one pile into the ground or seabed.

In an embodiment of the method, an exerted push force is transferred from the respective pushing actuator into the bridge assembly and transferred at least partially from the bridge assembly as a tension force into at least two or three of the remaining, stationary piles via the respective pile connection assemblies.

In an embodiment of the method, an exerted push force is transferred from the respective pushing actuator into the bridge assembly and transferred at least partially from the bridge assembly as a bending moment into at least two or three of the remaining, stationary piles via the respective pile connection assemblies.

In an embodiment of the method, the control device keeps a sum of the positive, vertical push forces and the negative, vertical pull forces of the actuators substantially zero.

In an embodiment of the method, an equilibrium point is defined within the polygon, wherein the control device keeps a sum of the moments applied by the actuators about said equilibrium point substantially zero.

In an embodiment of the method, the actuators are hydraulic cylinders, and wherein the control device regulates a pressure in said hydraulic cylinders.

In an embodiment of the method, the piles are tubular piles.

In an embodiment of the method, the piles are not interlocked and are in particular positioned at a horizontal distance from one another.

In an embodiment of the method, the bridge assembly moves downward together with the piles as they are pushed into the ground.

In an embodiment the method comprises:
positioning at least five piles in a polygonal configuration in a temporary location,
connecting the device according to the assembly to the at least five upper parts of the at least five piles,
lifting the combination of the device and the at least five piles connected thereto to a target location on a seabed or on the ground.

In an embodiment of the method, a cycle is carried out, wherein each cycle comprises the following steps in the sequence as indicated:
pushing the first pile over a distance into the ground or seabed,
pushing the second pile over a distance into the ground or seabed,
pushing the third pile over a distance into the ground or seabed,
pushing the fourth pile over a distance into the ground or seabed,
pushing the fifth pile over a distance into the ground or seabed.

In an embodiment of the method, each cycle further comprises pushing any subsequent pile over a distance into the ground or seabed.

In an embodiment of the method, a cycle is made, wherein each cycle comprises the following steps in the sequence as indicated:
pushing the first pile and second pile simultaneously over a distance into the ground or seabed,
pushing the third pile and fourth pile simultaneously over a distance into the ground or seabed,
pushing the fifth pile and sixth pile simultaneously over a distance into the ground or seabed.

In an embodiment of the method, each cycle further comprises pushing subsequent pairs of piles over a distance into the ground or seabed.

In an embodiment of the method, groups of three piles or more are pushed into the ground or seabed simultaneously.

In an embodiment of the method, a cycle is made comprising a combination of pushing one pile into the ground and pushing at least two piles simultaneously into the ground or seabed.

In an embodiment of the method, the first step or the last step of the cycle comprises keeping at least one or two actuators substantially stationary while retracting the remaining actuators for pushing the at least one or two piles corresponding to the at least one or two substantially stationary actuators into the ground or seabed, and wherein the other steps comprise extending the at least one or two actuators for pushing the at least one or two piles corresponding to the at least one or two actuators into the ground or seabed.

In an embodiment of the method, the actuators comprise a hydraulic cylinder comprising a valve, wherein the actuators are kept substantially stationary by closing the valve in order to prevent a hydraulic medium from circulating.

In an embodiment of the method, the device is lifted by and suspended from a crane on an installation vessel at sea.

In an embodiment of the method, each of the at least five piles is pushed into the ground through a respective pile sleeve at a bottom end of a jacket.

A method for pulling at least five piles out of the ground or seabed comprises:
connecting the device according to the first aspect of the invention to the upper ends of the piles, wherein each pile connection assembly is connected to an associated pile,
alternately pulling at least one of the piles over a distance out of the ground or seabed by alternately
   retracting the at least one or at least two actuators which are associated with the at least one or at least two piles, and/or by
   keeping at least one or at least two actuators associated with the at least one or at least two piles being pulled out substantially stationary while extending at least three or at least four of the remaining actuators, and/or by
   keeping at least one or at least two actuators associated with the at least one or at least two piles being pulled out substantially stationary while retracting at least two opposite actuators, thereby pivoting the bridge assembly about a pivot axis extending between said at least one actuator and said at least two opposite actuators.

The invention according to the first aspect further relates to a pile support frame provided on an installation vessel, wherein the pile support frame is configured to support at least five piles in a polygonal configuration and in a substantially vertical orientation and parallel to one another, wherein the pile support frame is open at an upper side, allowing the at least five piles to be gripped by the device.

In an embodiment the pile support frame comprises pile supports which are configured to support the piles at a distance from one another and with the upper part faces of the piles substantially flush.

The invention according to the first aspect yet further relates to a vessel comprising:
the device according to the first aspect of the invention,
a pile support frame, and
a crane, wherein the crane is configured to lift the device and move the device to above the pile support frame to allow the device to being connected to piles provided in the pile support frame.

### Second Aspect

In a second aspect of the present invention, a helical pile is provided for installation into the ground or seabed, the pile comprising:
a first tubular section having a length and a first outer diameter, the first tubular section comprising a first end and an opposite, second end, the first end being configured to be inserted into the ground or seabed,
a first helical section provided between the first end and second end or at the first end, the first helical section having a first pitch and a first pitch orientation,
a second helical section provided between the first helical section and the second end at a distance from the first helical section, the second helical section having a second pitch and the first pitch orientation, wherein the second pitch is different from the first pitch.

The second aspect may be combined with the first aspect, but the second aspect may also be independent from the first aspect of the invention.

The helical pile is not a drill bit.

An advantage of the second aspect is that the difference between the first pitch and second pitch can provide an increase in both the tension capacity and the compression capacity of the pile when installed in the ground or seabed. This is further explained in the detailed description of the figures.

In an embodiment of the helical pile, the first helical section extends away from an outer surface of the first tubular section.

In an embodiment of the helical pile, the second helical section extends away from the outer surface of the first tubular section.

In an embodiment of the helical pile, the first helical section and the second helical section comprise a helical plate.

In an embodiment of the helical pile, the second pitch is smaller than the first pitch.

In an embodiment of the helical pile, the first end comprises a penetrating section configured to penetrate the soil.

In an embodiment of the helical pile, the penetrating section has a conical shape converging from the first end.

In an embodiment of the helical pile, an outer diameter of the first and/or second helical section is at least 1.5 times the first outer diameter.

In an embodiment of the helical pile, an outer diameter of the first helical section and/or second helical section increases in a direction from the first end towards the second end.

In an embodiment of the helical pile, the distance between the first helical pile and the second helical pile is at least 3 times the first outer diameter.

In an embodiment of the helical pile, the first diameter is constant between the first helical section and the second helical section.

In an embodiment of the helical pile, the helical pile has a substantially constant first outer diameter.

In an embodiment of the helical pile, the helical pile comprises a second tubular section connected to the second end of the first tubular section, wherein the second tubular section has a second outer diameter which is larger than the first outer diameter.

In an embodiment of the helical pile, the outer diameter of the first and second helical sections is equal to or smaller than the second outer diameter.

In an embodiment of the helical pile, the first tubular section and the second tubular section are connected via a tapered section.

In an embodiment of the helical pile, the first helical section and/or second helical section comprises a single rotation helix or a helix with a rotation higher than one.

In an embodiment of the helical pile, the first helical section and/or the second helical section comprises a circular helix.

In an embodiment of the helical pile, a top end of the helical pile comprises a female mating part configured to be engaged by a male mating part of the pile connector associated with a rotating actuator for rotating the pile about its longitudinal axis, or vice versa.

In an embodiment of the helical pile, the female part is configured to provide a bayonet coupling with the male part of the rotating actuator.

The second aspect of the invention further provides a method for installing a helical pile according to the second aspect of the present invention, the method comprising the steps:
positioning the helical pile on the ground or the seabed in an upright orientation, wherein the first end is in contact with the ground or the seabed, and wherein the first helical section engages the ground or the seabed,
moving the helical pile into the ground by rotating the helical pile about its longitudinal axis in a direction corresponding with the first pitch orientation of the helical sections, until the first helical section and the second helical section are both located at a predetermined distance below the ground or seabed,
wherein the pile is moved downward into the ground or seabed over a distance equal to M times the first pitch of the first helical section by completely rotating the helical pile N times about its longitudinal axis, wherein N is greater than M.

In an embodiment of the method, the helical pile comprises the first helical section having the first pitch and a second helical section having a second pitch, wherein the second pitch is smaller than the first pitch.

In an embodiment of the helical pile, the second pitch is M/N times the first pitch.

Further a method is provided for installing at least two helical piles according to the present invention simultaneously, wherein a first helical pile comprises helical sections with a clockwise first pitch orientation when seen in top view, and wherein a second helical pile comprises helical sections with a counter clockwise first pitch orientation when seen in top view, the method comprising the steps:
positioning the helical piles on the ground or the seabed in an upright orientation, wherein the first ends are in contact with the ground or the seabed, and wherein the first helical sections engages the ground or the seabed,
providing an installation device comprising
   a bridge assembly which when seen in top view defines at least two connecting locations,
   at least two pile connection assemblies via which in use each of the at least two helical piles is connected to the bridge assembly, wherein each pile connection assembly comprises:
      a rotating actuator configured to rotate in a clockwise and/or a counter clockwise direction relative to the bridge assembly when seen in top view,
      a pile connector connected to the actuator, wherein each pile connector is configured to be connected to an upper part of a helical pile which is to be moved into the ground or seabed, wherein the pile connector is configured to be rotated by the associated actuator
connecting a first pile connector of the installation device to the first helical pile and a second pile connector of the installation device to the second helical pile,
rotating the first helical pile in the clockwise pitch orientation via the first pile connector and the associated actuator and simultaneously rotating the second helical pile in the counter clockwise direction via the second pile connector and the associated actuator.

In an embodiment of the method, the helical piles are moved downward into the ground or seabed over a distance equal to M times the first pitch of the first helical section by completely rotating the helical pile N times about its longitudinal axis, wherein N is greater than M.

The second aspect of the invention further provides a method for removing an installed helical pile according to the second aspect of the invention from the ground or seabed, the method comprising the step of rotating the pile in a direction opposite to the first pitch orientation of the helical sections.

In an embodiment of the method, at least two helical piles are removed simultaneously, wherein a first helical pile comprises helical sections in a clockwise pitch orientation when seen in top view, and wherein a second helical pile comprises helical sections in a counter clockwise pitch orientation when seen in top view, the method comprising the steps:
providing an installation device comprising
   a bridge assembly which when seen in top view defines at least two connecting locations,
   at least two pile connection assemblies via which in use each of the at least two helical piles is connected to the bridge assembly, wherein each pile connection assembly comprises:
      a rotating actuator configured to rotate in a clockwise and/or a counter clockwise direction relative to the bridge assembly when seen in top view,
      a pile connector connected to the actuator, wherein each pile connector is configured to be connected to an upper part of a helical pile which is to be moved into the ground or seabed, wherein the pile connector is configured to be rotated by the associated actuator
connecting a first pile connector of the installation device to the first helical pile and a second pile connector of the installation device to the second helical pile,
rotating the first helical pile in the counter clockwise pitch orientation via the first pile connector and the associated actuator and simultaneously rotating the second helical pile in the clockwise direction via the second pile connector and the associated actuator.

### Third Aspect

In a third aspect the present invention provides a support structure for supporting a top structure above the ground or a seabed, the support structure comprising:
at least one support pile having a length and a first outer diameter, the at least one support pile comprising
   an upper part configured and intended to extend above the ground or the seabed, wherein the upper part of the support pile is configured to be connected to the top structure,
   a lower part configured to be in contact with the ground or seabed,
a plurality of foundation guides connected to the lower part of the at least one support pile, each foundation guide having an opening extending in a direction of the at least one support pile, the opening having an opening diameter, wherein each foundation guide is configured to accommodate a foundation pile, wherein the foundation pile is configured to extend through the foundation guide and at least partly into the ground or the seabed.

The third aspect may be combined with the first aspect and/or the second aspect. However, the third aspect may also be independent from the first and second aspect.

An advantage of the third aspect is that the support structure may be of a shorter length and diameter than a monopile having the same lateral and overturning capacity when the support structure is combined with foundation piles. This is beneficial, because the current development of ever increasing wind turbine dimensions makes the use of monopiles more and more difficult.

In an embodiment the support structure comprises:
one support pile having a length and a first outer diameter, the support pile comprising
   an upper part configured and intended to extend above the ground or the seabed, wherein the upper part of the support pile is configured to be connected to the top structure,
   a lower part, wherein at least a bottom part of the lower part is configured and intended to extend into the ground or the seabed,
a plurality of foundation guides connected to the lower part of the support pile, each foundation guide having an opening extending in a direction of the support pile, the opening having an opening diameter, wherein each foundation guide is configured to accommodate a foundation pile, wherein the foundation pile is configured to extend through the foundation guide and at least partly into the ground or the seabed.

In an embodiment of the support structure, the foundation guides are provided at a distance above a bottom end of the at least one support pile.

In an embodiment of the support structure, a longitudinal axis of the opening of the foundation guides extends parallel to a central axis of the at least one support pile.

In an embodiment of the support structure, in top view the foundation guides are arranged around the at least one support pile.

In an embodiment of the support structure, in top view the foundation guides are arranged equidistantly around the at least one support pile.

In an embodiment of the support structure, the support pile comprises a widening part extending over a distance upwards from the lower end, the widening part having a second outer diameter which is greater than the first outer diameter, wherein in top view the foundation guides extend outside the first outer diameter and inside the widening part having the second outer diameter.

In an embodiment of the support structure, a length of the foundation guide is at least twice the opening diameter of the opening of the foundation guide.

In an embodiment of the support structure, the foundation guide is a sleeve.

In an embodiment of the support structure, the foundation guide comprises a centering member around the opening at the top end thereof, the centering member being configured to center and guide a bottom end of a foundation pile into the opening of the foundation guide.

In an embodiment of the support structure, at least one annular recess is provided in an inner side of the sleeve, the annular recess being configured and intended to form a female part of a swaging connection between the foundation pile and the sleeve.

In an embodiment the support structure comprises at least three foundation guides.

In an embodiment of the support structure, the foundation guides are connected to each other via a foundation frame, the foundation frame being connected to and extending around the at least one support pile for providing stiffness to the connection between the foundation guides and the at least one support pile.

In an embodiment of the support structure, a bottom end of the foundation guide is configured and intended to rest on the ground or the seabed.

In an embodiment of the support structure, the opening diameter of the foundation guides is smaller than the first outer diameter, in particular at least 3 times smaller.

In an embodiment the support structure has a single support pile.

In an embodiment of the support structure, the opening of the foundation guide is located at less than 2 times the opening diameter away from an outer surface of the at least one support pile, in particular less than once the opening diameter.

In an embodiment of the support structure, the lower part of the support pile is configured to extend into the ground or seabed by a distance of at least one time the first outer diameter of the support pile.

In an embodiment of the support structure, a suction bucket is provided inside the lower part of the support pile for moving the lower part of the support pile into the ground or the seabed via suction.

In the third aspect further a support assembly is provided for supporting a top structure above the ground or a seabed, the support assembly comprising:
a support structure according to the third aspect of the invention,
a plurality of foundation piles, wherein each foundation pile extends through a respective foundation guide and is configured and intended to extend at least partly into the ground or the seabed over a foundation depth for providing resistance against overturning of the support pile.

In an embodiment of the support assembly, wherein the foundation piles are arranged around the first outer diameter of the at least one support pile.

In an embodiment of the support assembly, the first outer diameter of the support pile is greater than an outer diameter of the foundation piles.

In an embodiment of the support assembly, the foundation piles have the same outer diameter.

In an embodiment of the support assembly, the foundation piles are arranged equidistantly around the support pile.

In an embodiment of the support assembly, in top view the foundation piles define a cyclic polygon.

In an embodiment the support assembly comprises at least three foundation piles.

In an embodiment of the support assembly, the top structure is a wind turbine.

In an embodiment of the support assembly, the foundation pile comprises at least one helix at a lower end thereof extending around the outer surface, wherein the foundation pile is configured to be rotated about its longitudinal axis during installation into the ground or the seabed.

In an embodiment of the support assembly, a plurality of foundation piles are helical piles according to the second aspect of the invention.

In an embodiment of the support assembly, prior to installation at least 50 percent of the length of the foundation piles are located adjacent the support pile, in particular at least 60 percent, more in particular at least 80 percent.

In an embodiment of the support assembly, after installation of the support assembly at least 60 percent of the length of the foundation piles extends below the support pile.

The third aspect of the present invention further provides a floating vessel for transporting at least one support assembly, wherein during transport the at least one support assembly is provided on a deck of the floating vessel in a vertical orientation.

The present invention according to the third aspect provides a method for installing the support assembly according to the invention, the method comprising the steps of:
positioning the support pile with its bottom end on the ground or the seabed and moving a part of the lower part of the support pile into the ground or the seabed,
positioning the foundation piles in the foundation guides and on the ground or the seabed and moving the foundation piles at least partly into the ground or the seabed over the foundation depth.

In an embodiment of the method, the at least one support pile is positioned on the ground or the seabed first, and the foundation piles are subsequently positioned on the ground or the seabed by inserting the foundation piles through the foundation guides.

In an embodiment of the method, the at least one support pile and the foundation piles are lowered and positioned on the ground or the seabed simultaneously by a crane, in particular by lowering the support assembly to the ground or the seabed with said crane, wherein the foundation piles already extend through the foundation guides.

In an embodiment of the method, the foundation piles are moved into the ground or the seabed by an installation device, wherein the installation device comprises:
a bridge assembly which when seen in top view defines a plurality of connecting locations corresponding to the plurality of foundation piles,
a plurality of pile connection assemblies via which in use each foundation pile is connected to the bridge assembly, wherein each pile connection assembly comprises:
   a pile connector wherein each pile connector is configured to be connected to an upper part of each foundation pile which is to be moved into the ground or seabed,
   wherein at least a plurality of the pile connection assemblies comprise an actuator which extends downward from the respective connecting location, wherein each actuator comprises an upper actuator part and a lower actuator part, wherein the upper actuator part is connected to the bridge assembly, wherein the lower actuator part is connected to a corresponding pile connector.

In an embodiment of the method, the bridge assembly comprises a central opening through which the at least one support pile extends, and wherein the installation device moves downward relative to the support pile during installation of the foundation piles.

In an embodiment of the method, at least two foundation piles comprise a helix at a lower part thereof, wherein at least two actuators of the installation device are rotatable for moving corresponding said foundation piles comprising the helix into the ground or the seabed by rotating the foundation piles about their respective longitudinal axis.

In an embodiment of the method, the at least two foundation piles connected to the rotatable actuators are helical piles according to the second aspect of the invention.

In an embodiment of the method, the support assembly is connected to a lowering assembly for lowering and positioning the support assembly on the ground or the seabed.

In an embodiment of the method, the lowering assembly comprises the installation device for moving the foundation piles into the ground or the seabed.

In an embodiment of the method, the pile connectors of the installation device are connected to the foundation piles during lowering and positioning of the foundation piles.

In an embodiment of the method, the foundation piles extend through the foundation guides during the lowering and positioning of the support assembly.

In an embodiment of the method, the foundation piles are pushed into the ground by a device according to the first aspect of the invention comprising a central opening, wherein said device extends around the at least one support pile, wherein the at least one support pile extends through the central opening.

In an embodiment of the method, the foundation piles are moved into the ground or the seabed by hammering, screwing, pushing, or a combination thereof.

In an embodiment the method further comprises fixating the foundation piles to their respective foundation guide.

In an embodiment of the method, the foundation piles are fixated to their respective foundation guide by grouting, swaging, or a combination thereof.

In an embodiment of the method, after the support assembly is installed, the installation device is moved away from the support assembly, in particular by moving the installation device upward relative to the support pile.

In an embodiment of the method, the support assembly is installed in a vertical orientation.

In an embodiment of the method, the foundation piles are moved into the ground or the seabed vertically.

In an embodiment of the method, a suction bucket is provided inside the lower part of the support pile, and wherein the lower part is moved into the ground or the seabed at least in part via suction.

In an embodiment of the method, the foundation piles are helical piles, and wherein the lower part of the at least one support pile is moved into the ground or seabed at least in part by a downward force exerted by the helical piles on the foundation guides or by pushing the installation device connected to the foundation piles upwards relative to the support pile.

In an embodiment of the method, after the foundation piles are installed the orientation of the support pile is adjusted by moving the foundation piles relative to the support pile or by moving the support pile relative to the foundation piles.

The present invention according to the third aspect further provides an installation device for moving foundation piles of a support assembly into the ground or the seabed, the installation device comprising:
a bridge assembly which when seen in top view defines a plurality of connecting locations corresponding to the plurality of foundation piles,
a plurality of pile connection assemblies via which in use each foundation pile is connected to the bridge assembly, wherein each pile connection assembly comprises:
   a pile connector wherein each pile connector is configured to be connected to an upper part of each foundation pile which is to be moved into the ground or seabed,
   wherein at least a plurality of the pile connection assemblies comprise an actuator which extends downward from the respective connecting location, wherein each actuator comprises an upper actuator part and a lower actuator part, wherein the upper actuator part is connected to the bridge assembly, wherein the lower actuator part is connected to a corresponding pile connector.

In an embodiment of the installation device, the bridge assembly comprises a central opening through which the at least one support pile is configured to extend, wherein the bridge assembly comprises a plurality of guides for guiding the movement of the installation device relative to the support pile, wherein the guides extend into the central opening.

In an embodiment of the installation device, the guides are configured to engage the support pile and to transfer a bending moment of the foundation piles as a force into the support pile via the bridge assembly.

In an embodiment of the installation device, the pile connector comprising a male or female mating part configured to mate with a corresponding mating part of a foundation pile.

In an embodiment of the installation device, the installation device comprises an engaging member configured to engage the support pile and to exert a force on the support pile in a vertical direction.

In an embodiment of the installation device, the at least two rotating actuators are counter rotating relative to each other.

These and other aspects of the invention will be more readily appreciated as the same becomes better understood by reference to the following detailed description and considered in connection with the accompanying drawings in which like reference symbols designate like parts.

### BRIEF DESCRIPTION OF THE FIGURES

FIG. 1A shows a perspective view of an embodiment of a device according to a first aspect of the invention.

FIG. 1B shows a perspective view of another embodiment of a device according to a first aspect of the invention.

FIGS. 2A-2C show a perspective view of the device of FIG. 1B pushing in one pile by extending one actuator.

FIG. 3A-3C show a perspective view of the device of FIG. 1B pushing in two piles by extending two associated actuators.

FIGS. 4A-4C show a perspective view of the device of FIG. 1B pushing in one pile by retracting the remaining actuators.

FIGS. 5A-5C show a perspective view of the device of FIG. 1B pushing in two piles by retracting the remaining actuators.

FIGS. 6 and 7 show in perspective view another embodiment of the device according to the first aspect of the invention pushing in two piles by pivoting the bridge assembly.

FIG. 8-11 show different views of another embodiment of the device according to the invention.

FIGS. 12-15 show different steps of installing at least five pile using a device according to the invention.

FIG. 16-26 schematically show top views of force distributions for different polygonal configurations of devices according to the invention.

FIG. 27 shows a side view of an embodiment of a helical pile according to a second aspect of the present invention.

FIG. 28 shows a side view of an embodiment of a helical section with increasing diameter.

FIG. 29 shows a perspective view of another embodiment of a helical pile according to the second aspect of the invention, comprising a second tubular section.

FIGS. 30-32 schematically show the working principles of helical sections.

FIGS. 33-35 show in perspective view an embodiment of installing a helical pile according to the invention.

FIG. 36 shows in perspective view an embodiment of installing two helical piles simultaneously.

FIG. 37 shows in perspective view a close up of the first ends of the two helical piles of FIG. 36.

FIG. 38 shows a perspective view of an embodiment of a support structure and a support assembly according to a third aspect of the present invention.

FIG. 39A shows a cross-sectional view of another embodiment of a support structure and support assembly comprising a widening part.

FIG. 39B shows a top view of the embodiment of FIG. 39A.

FIG. 40 shows a cross-sectional view of another embodiment of the support structure according to the invention, comprising a suction bucket.

FIGS. 41A-41E show different steps of an embodiment of a method for installing a support assembly according to the present invention.

FIG. 42 shows different steps of an installation method for a support assembly comprising six push-in piles using a device according to the first aspect of the invention.

FIG. 43A shows different steps of an installation method for a support assembly comprising three piles which are hammered in by a hammering device.

FIG. 43B schematically shows a step of the method of FIG. 43A.

FIG. 44 shows in cross-section a swaged connection between a foundation pile and a foundation guide of the support assembly.

FIG. 45 shows another embodiment of an installation method for a support assembly according to the invention.

FIG. 46 shows yet another embodiment of an installation method for a support assembly according to the invention.

### DETAILED DESCRIPTION OF THE FIGURES

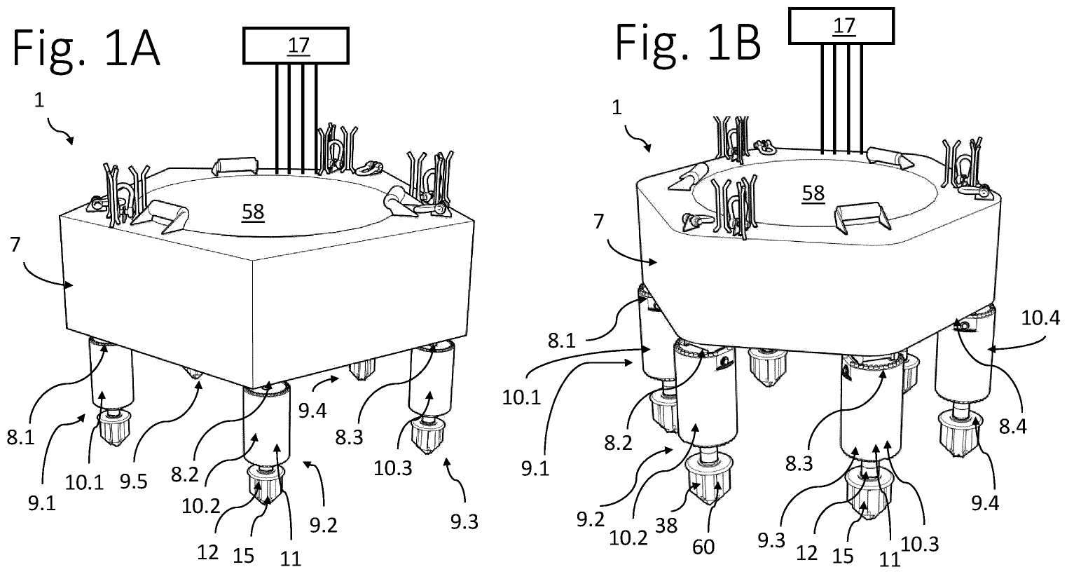

Turning to FIGS. 1 to 7, in a first aspect of the invention a first embodiment of a device 1 is shown for pushing at least five piles into the ground or into a seabed 3. The device 1 is also capable of pulling at least five piles 2 out of the ground or seabed 3. In fact, all of the shown embodiments of the device 1 are configured to pull out at least five piles. The device 1 in FIG. 1A is configured to push five piles into the ground or seabed 3. The device 1 in FIG. 1B is for pushing six piles 2.1, 2.2, 2.3, 2.4, 2.5, 2.6 into the ground or seabed 3. It is to be understood that the invention is suited for at least five piles and that in the following description the embodiment for six piles is merely exemplary.

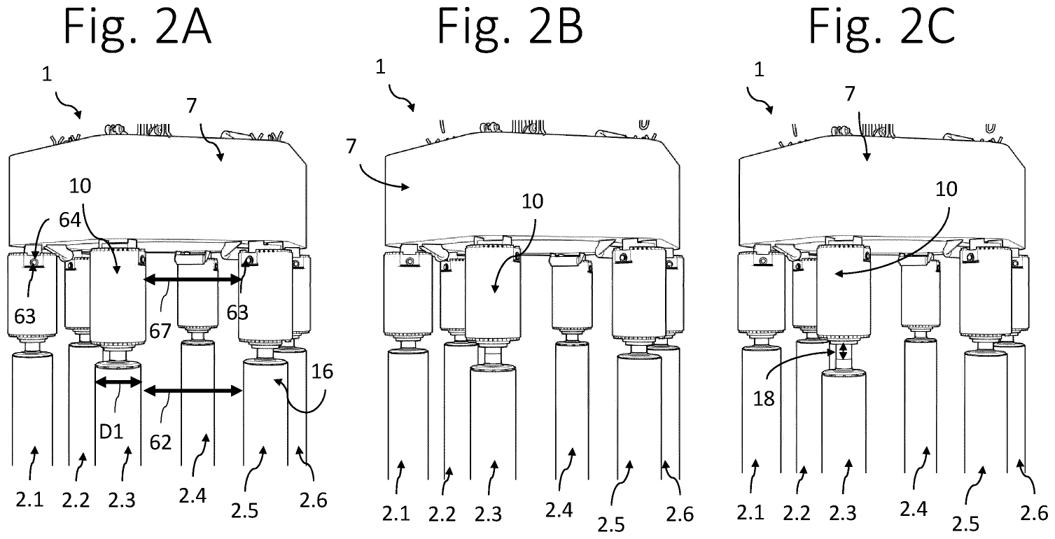

In top view at least a number of the at least five piles define a polygonal configuration 5, wherein any of the remaining at least five piles are located within the polygon. In the shown embodiment of FIGS. 2 to 6 all six piles define the polygon, in particular a cyclic polygon 238. Hence, there are no remaining piles located within the polygon 24 for said embodiment. A cyclic polygon provides for a load distribution which is easier to regulate.

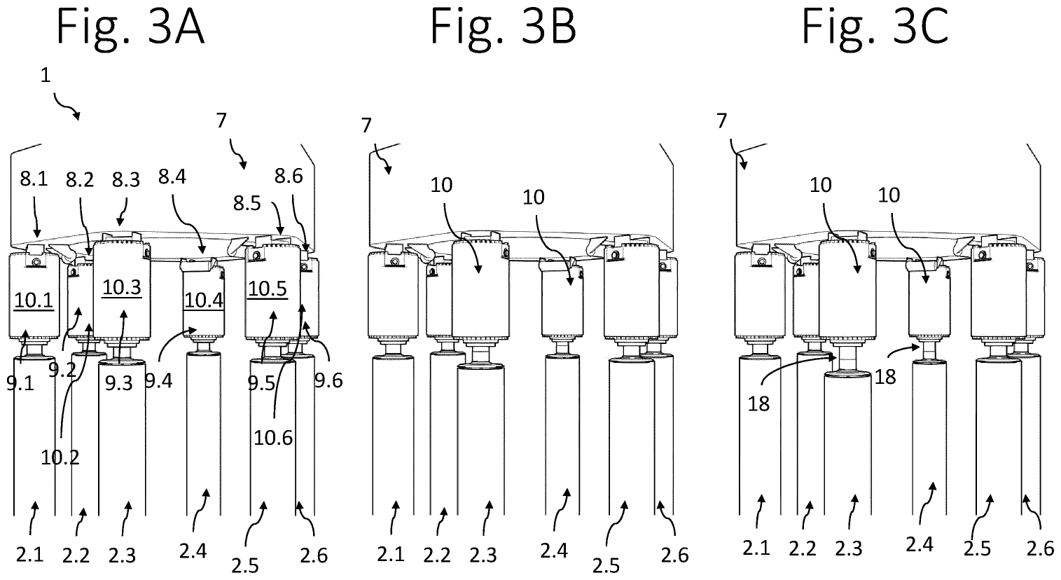

The device 1 comprises a bridge assembly 7 which when seen in top view defines at least five connecting locations 8.1, 8.2, 8.3, 8.4, 8.5, 8.6, see FIG. 3A.

The device 1 comprises six pile connection assemblies 9.1, 9.2, 9.3, 9.4. 9.5, 9.6 via which in use each of the six piles is connected to the bridge assembly 7. Each pile connection assembly 9 comprises an actuator 10.1, 10.2, 10.3, 10.4, 10.5, 10.6 which extends downward from the respective connecting location 8.

Each actuator 10 comprises an upper actuator part 11 and a lower actuator part 12. The upper actuator part 11 is connected to the bridge assembly 7. The actuator 10 is configured to extend in order to move the lower actuator part 12 downward relative to the upper actuator part 11 and/or to retract in order to move the lower actuator part 12 upward relative to the upper actuator part 11.

The pile connection assembly comprises a pile connector 15 connected to the lower actuator part 12. Each pile connector 15 is configured to be connected to an upper part 16 of a pile which is to be pushed into the ground or seabed 3. The pile connector 15 is configured to move downward or upward relative to the upper actuator part 11 together with the associated lower actuator part 12 during the respective extension or retraction. It may also be possible to connect two pile connectors 15 to one actuator 10, so one actuator 10 can push in or pull out two piles.

In top view the bridge assembly 7 has a circular or polygonal shape and comprises a central opening 58, wherein the bridge assembly 7 extends around this central opening 58.

The device 1 is configured to drive all piles vertically into the ground or seabed 3. All actuators 10 and all pile connectors 15 are therefore oriented vertically.

Each pile connector 15 comprises an insertable part 60 which is configured to be inserted into an upper part 16 of a tubular pile.

Each pile connector 15 comprises one or more gripper actuators 38 to grip the upper part 16 of the tubular piles.

The piles 2 are not interlocked. Hence, the device 1 is configured for pushing piles into the ground or seabed 3 which are not interlocked.

The piles 2 are positioned at a horizontal distance from one another and do not contact one another.

The piles may be spaced as closely together as possible. A pile spacing distance 62 (FIG. 2A) is however limited by the minimum required spacing 67 between the actuators 10 and the fabrication of the device 1 according to the invention.

It was found that the tension and compression capacity of the piles increase exponentially at a pile spacing of 2 pile diameters D1 and less, wherein the tension capacity has a steeper exponential increase with decreasing pile spacing compared to the compression capacity.

It was further found that a spacing between 2 to 4 pile diameters D1 already has a more or less linearly increasing effect on the difference between tension and compression capacity, with the same advantage of allowing the deadweight of the device 1 to be reduced.

Each pile connection assembly 9 is connected to the bridge assembly 7 via a hinge 63. The hinge 63 can reduce the bending moments on the cylinders 43 of the actuators 10 while pushing. Without a hinge 63 the actuator 10 which is pushed would receive a moment around the connection location of the hinge 63 or hinge axis 23.

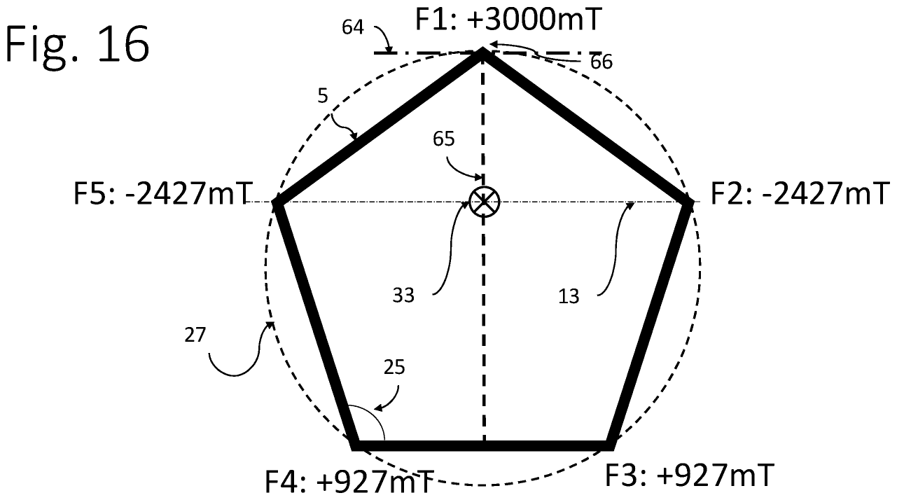

The hinge 63 has a hinge axis 64 which extends perpendicular to the bisector 65 of the associated corner 66 of the polygon, see for example FIG. 16.

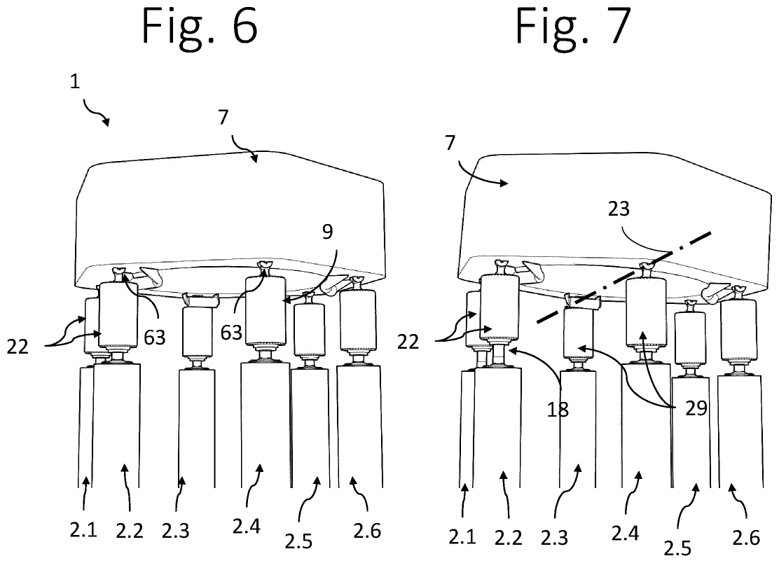

The embodiment as shown in FIGS. 6 and 7 comprises hinges 63 between the pile connection assemblies 9 and the bridge assembly 7 of the ball joint type which have a plurality of hinge axes. This provides more freedom of motion between the respective pile connection assembly and the bridge assembly 7 in order to allow the pivoting motion of the bridge assembly 7, as shown in FIG. 7. In this embodiment substantially no bending moments are transferred from the pile actuators 10 to the bridge assembly 7 and vice versa.

The device 1 comprises a control device 17 which is configured for alternately pushing at least one of the at least five piles 2 over a distance 18 into the ground or seabed 3 by applying a vertical force via the associated actuator 10 to the at least one pile which is being pushed into the ground or seabed 3.

The distance 18 over which the piles are pushed into the ground are shown as the distance the actuators extend or retract in the FIGS. 2 to 7.

The control device 17 is configured for regulating at least the vertical force which is exerted by the actuator 10 associated with the pile which is being pushed in and/or at least the vertical forces which are exerted by at least two of the remaining actuators 10 on associated remaining, stationary piles. The control device 17 regulates said vertical force in order to have the at least one pile which is pushed into the ground or seabed 3 receive a greater vertical force than each of the remaining piles. There are multiple ways to push the piles into the ground, as will be further elucidated later.

The control device 17 may be configured for alternately pushing at least one of the at least five piles over a distance 18 into the ground or seabed 3 by alternately:
having at least one of the actuators 10 associated with the at least one pile 2 being pushed in extend, and/or by
keeping at least one actuator 10 associated with the at least one pile 2 being pushed in substantially stationary while retracting at least three of the remaining actuators 10, and/or by
keeping at least one actuator 10 associated with the pile 2 being pushed in substantially stationary while extending at least two opposite actuators 22, thereby pivoting the bridge assembly 7 about a pivot axis 23 (FIG. 7) extending between said at least one actuator 10 and said at least two opposite actuators 22.

An order of the three options may be combined during installation of the piles with the device 1 according to the invention. Also the options itself may be combined. For example the first and second option can be combined by extending at least one actuator 10 and retracting the remaining actuators 10.

FIGS. 2A-2C and FIG. 3A-3C schematically show the first option, wherein at least one actuator 10 extends. FIGS. 2A-2C show an embodiment wherein one pile 2.3 is pushed in over a distance 18 (FIG. 2C). FIGS. 3A-3C show an embodiment where two piles 2.3, 2.4 are pushed in simultaneously over a distance 18 (FIG. 3C). Here the control device 17 is configured for regulating at least the vertical force which is exerted by the at least one associated actuator 10 during the extension thereof in order to let the at least one pile which is pushed into the ground or seabed 3 receive a greater vertical force than each of the remaining piles 2.1, 2.2, 2.5, 2.6.

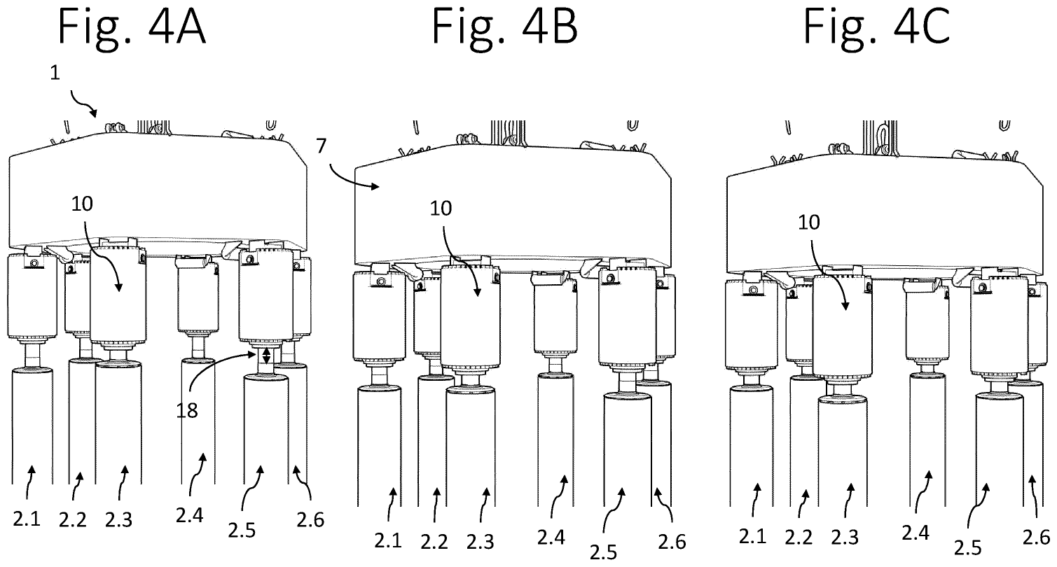

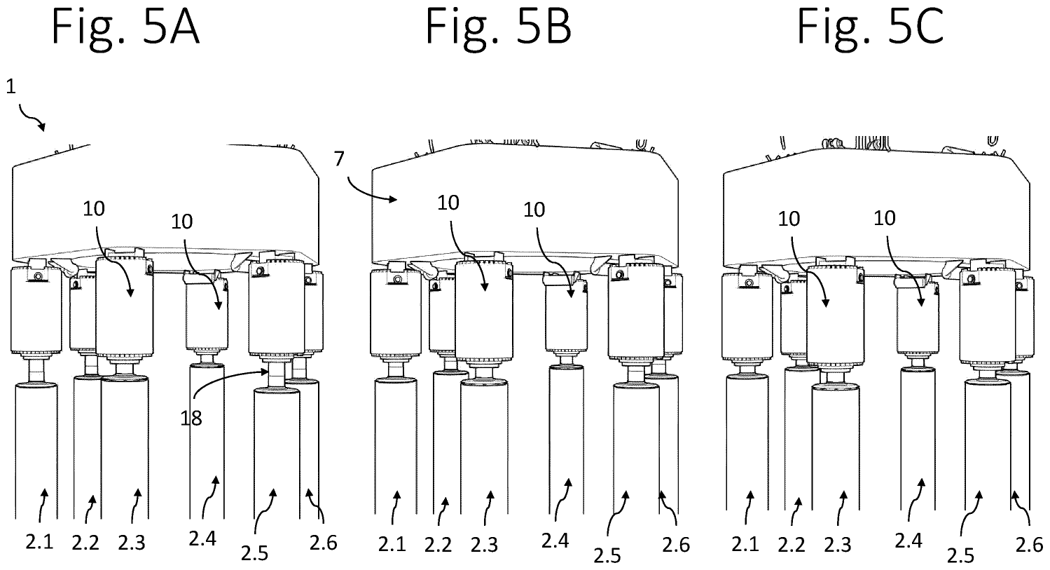

FIGS. 4A-4C and FIGS. 5A-5C schematically show the second option, wherein at least one actuator 10 associated with the pile 2 to be pushed in is kept substantially stationary. The remaining actuators 10 retract. FIGS. 4A-4C show an embodiment wherein one pile 2.3 is pushed in over a distance 18 (FIG. 4A). FIGS. 5A-5C show an embodiment wherein two piles 2.3, 2.4 are pushed in simultaneously over a distance 18 (FIG. 5A). Here the control device 17 is configured for regulating at least the vertical force which is exerted by the at least three retracting actuators 10 in order to let the at least one pile 2.3, 2.4 corresponding to the substantially stationary actuator 10 receive a greater vertical force than each of the remaining, stationary piles 2.1, 2.2, 2.5, 2.6.

FIGS. 6 and 7 schematically show the third option, wherein the bridge assembly 7 is pivoted about the pivot axis 23. The pivot axis 23 is different for each pile or pair of piles which is pushed in and does not remain in a horizontal plane. In the embodiment shown the piles 2.3, 2.4 adjacent the piles 2.5, 2.6 being pushed in are chosen as the pivot axis 23, wherein the pivot axis 23 extends through the hinges of the opposing actuators 29 associated with piles 2.3, 2.4. The opposing actuators 29 may be kept stationary during pushing. Here the control device 17 is configured for regulating at least the vertical force of the at least two opposite extending actuators 10 associated with piles 2.1, 2.2 in order to have the piles 2.5, 2.6 being pushed in receive a greater vertical force than each of the remaining, stationary piles 2.1, 2.2, 2.3, 2.4 for pushing the two piles 2.5, 2.6 into the ground or seabed 3 over a distance 18 (FIG. 7).

The at least one actuator 10 which is associated with the at least one pile which is being pushed into the ground or seabed 3 transfers the exerted vertical push force into the bridge assembly 7. Said push force is transferred at least partially from the bridge assembly 7 as a tension force into at least two of the remaining, stationary piles via the respective pile connection assemblies. It may also be possible to transfer the push force at least partially from the bridge assembly 7 as a bending moment into at least two of the remaining, stationary piles.

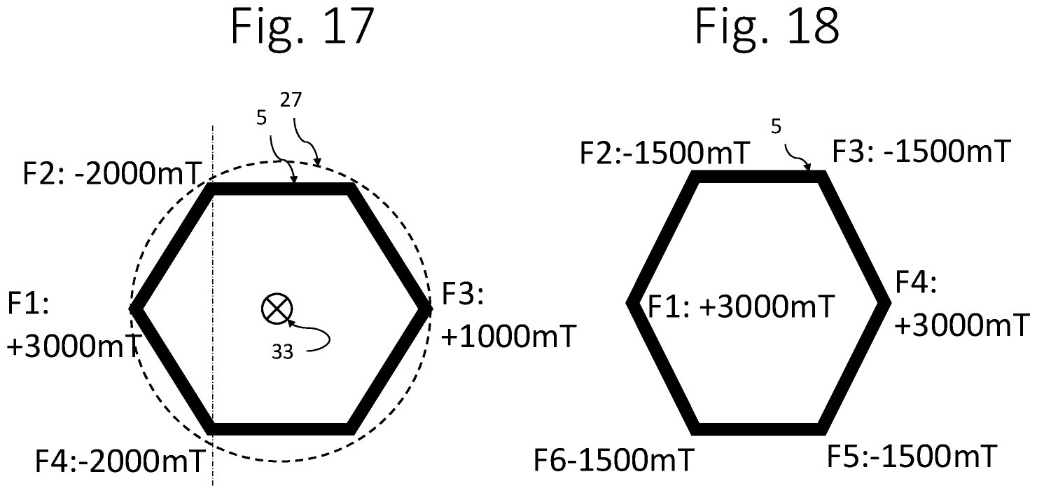

Different types of polygonal configurations 5 are possible. In the shown embodiment of FIGS. 1-7 the six pile connection assemblies are arranged as a cyclic polygon in top view, wherein all six piles are arranged equidistantly on a circumscribed circle 27 of the polygon, see also FIG. 17.

The polygonal configuration 5 can be a polygon 24 with angles 25 (FIG. 16) between 90-180 degrees. In top view the pile connection assemblies may be arranged on a circle or an ellipse. The pile connection assemblies 9 may be arranged equidistantly on a circumscribed circle or circumscribed ellipse of the polygon. It is also possible that the polygonal configuration 5 is an irregular polygon 28.

The control device 17 may be configured to keep a sum of the positive, vertical push forces and the negative, vertical pull forces of the actuators 10 substantially zero during the push in of the at least one pile.

An equilibrium point 33 is defined within the polygon. The control device 17 may be configured to keep a sum of the moments applied by the actuators 10 about said equilibrium point 33 substantially zero.

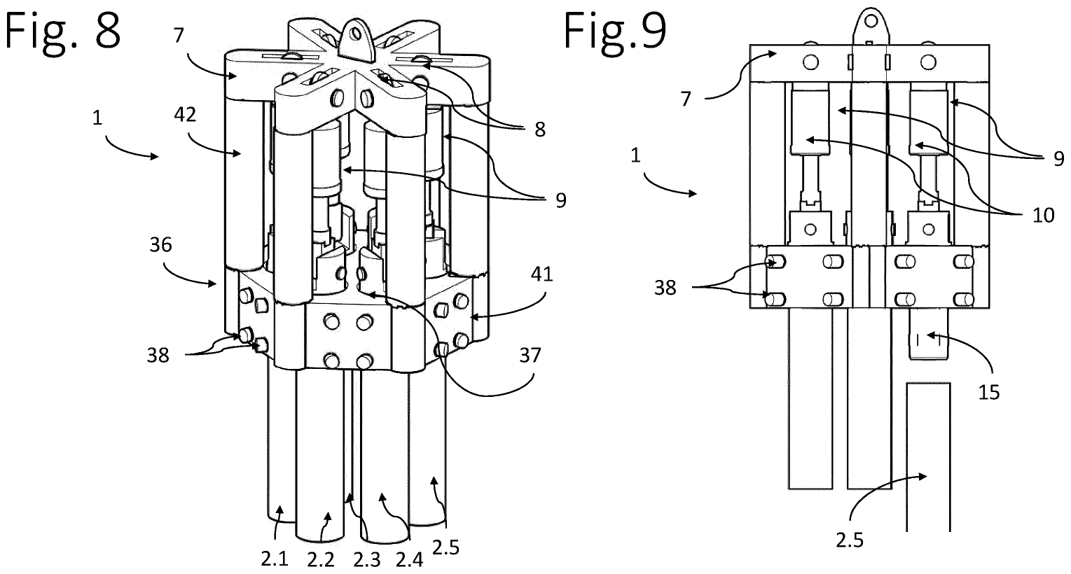

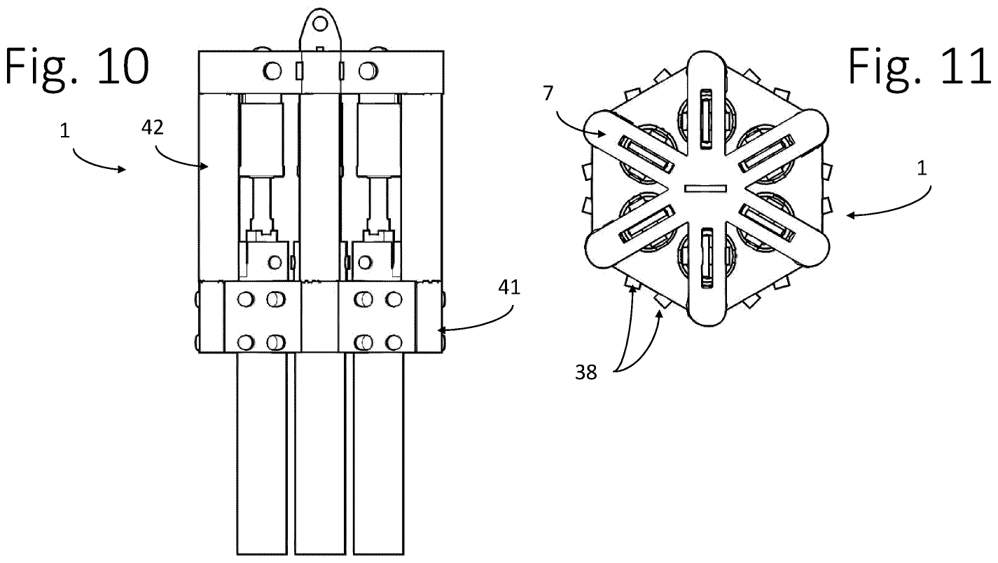

FIGS. 8-11 schematically show different views of a second embodiment of a device 1 according to the invention for pushing at least five piles 2.1, 2.2, 2.3, 2.4, 2.5 into the ground or seabed 3. This embodiment has no central opening 58. The shown second embodiment is configured to push in six piles. The sixth pile 2.6 is not visible. In FIG. 9 one pile 2.5 is disconnected from its associated pile connector 15 to show said pile connector 15.

A difference with the first embodiment of FIGS. 1-6 is that each pile connection assembly comprises a sliding assembly 36 which is rigidly connected to the bridge assembly 7. The sliding assembly 36 comprises a sleeve 37 and one or more gripper actuators 38 which can be switched between a gripping state and a released state.

In the released state the pile and/or pile connector 15 can slide through the sleeve 37. In the gripping state the sleeve 37 is rigidly connected to the pile and/or pile connector 15, allowing a tension force and a bending moment to be transferred from the bridge assembly 7 into the pile which is in the sleeve 37.

The pile connection assemblies 9 are rigidly connected to one another via a base frame 41 which is positioned below the bridge assembly 7 and which is rigidly connected to the bridge assembly 7 via at least one column 42. The sliding assemblies are connected to the base frame 41.

### Operation

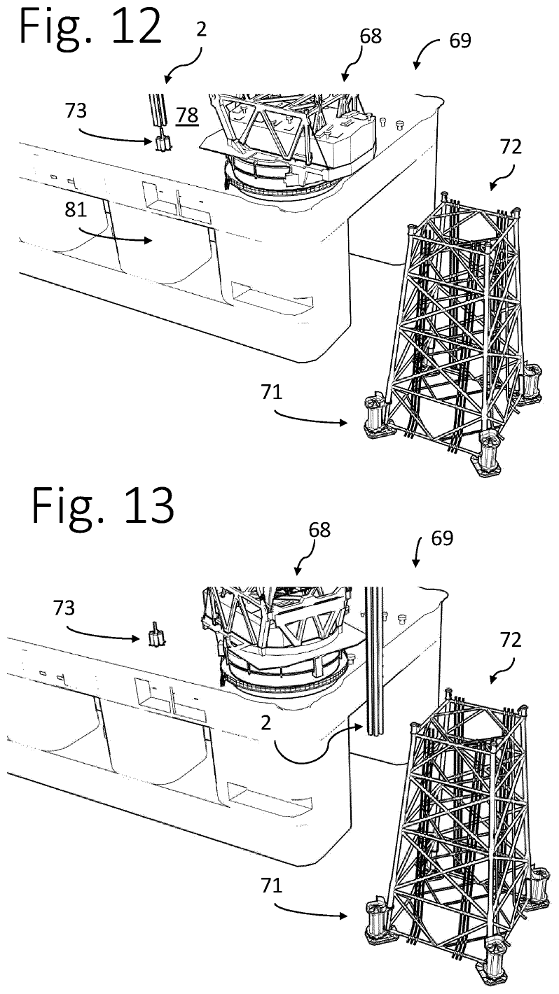

Turning to FIGS. 12 to 15, when the device 1 is to be used in an offshore environment, the device 1 may be operated from a vessel 69. The vessel 69 may be a semi-submersible, regular vessel, barge or any other type of vessel. In FIGS. 12 to 15 the second embodiment as shown in FIGS. 8-11 of the device 1 is used. The first embodiment of the device 1 may also be used.

A pile support frame 73 may be provided on the vessel 69. The pile support frame 73 is configured to support at least five piles 2 in a pickup configuration. In the pickup configuration, the at least five piles are positioned parallel to one another at mutual interspacing which corresponds to the interspacing between the connecting locations 8. Preferably the piles are oriented vertically or substantially vertically. In the embodiment of FIG. 12, the pile support frame 73 is located inside a column 81 of the semi-sub vessel 69 and an upper end of the pile support frame 73 is located at the deck level. In case of a regular hull, the pile support frame 73 may be located inside the hull.

Different embodiments of the pile support frame 73 are also possible. For instance the pile support frame 73 may be positioned on deck 78 and rise upward from the deck 78 or may be positioned in a moonpool. Or the pile support frame 73 may be provided on a cantilevered platform extending beyond a contour of the vessel 69.

In operation, the vessel 69 is positioned at a target location, for instance at a base or bottom end 71 of a leg of a jacket 72. The target location may obviously be any location at which piles need to be driven into the seabed 3. The device 1 can for instance be used for installing piles into an already installed (part) of a structure (e.g. jacket 72 or template or any other structure) or for so-called “pre-piling”, in case the structure or part thereof is not yet in place and eventually is placed over the pre-installed piles.

It is noted that pre-piling can be done with an intermediate template on the sea-floor, the use of a spacer frame could however act as a guidance frame that comes with the piles rather than pre-installing a temporary guidance frame. This would result in a reduction of execution time.

This could, when used for pre-piling, eliminate having a complex pre-pilling template with adjustable inclination systems.

At least five piles 2 are positioned in the pile support frame 73. The piles may be tubular.

The device 1 may be lifted from the deck 78 of a vessel 69 with a crane 68. The crane 68 lifts the device 1 and subsequently places the device 1 on the at least five piles. Next, the grippers are moved outward and grip the upper ends of the tubular piles, thereby connecting each pile connection assembly to an associated pile. The device 1 is now connected to the at least five piles.

Turning to FIG. 13, the crane 68 subsequently lifts the combination of the device 1 and the at least five piles from the pile support frame 73 and moves the combination to the target location. In order to improve the stability of the combination, temporary wires, braces, brackets, stops or similar device 1 may be provided to prevent the at least five piles 2 from colliding during the lift, to maintain a required spacing of the lower ends of the piles and to prevent the moving parts of the device 1 from moving.

Optionally, the device 1 can be equipped with a spacer frame to limit relative movement between the piles and between the piles and the device 1. This spacer frame can be hung off underneath the device 1 or be suspended on the piles itself, allowing to install and remove it in one lift or in two separate lifts.

The connection between the spacer frame and the device 1 can for instance be formed by either slings, chains or rigid materials.

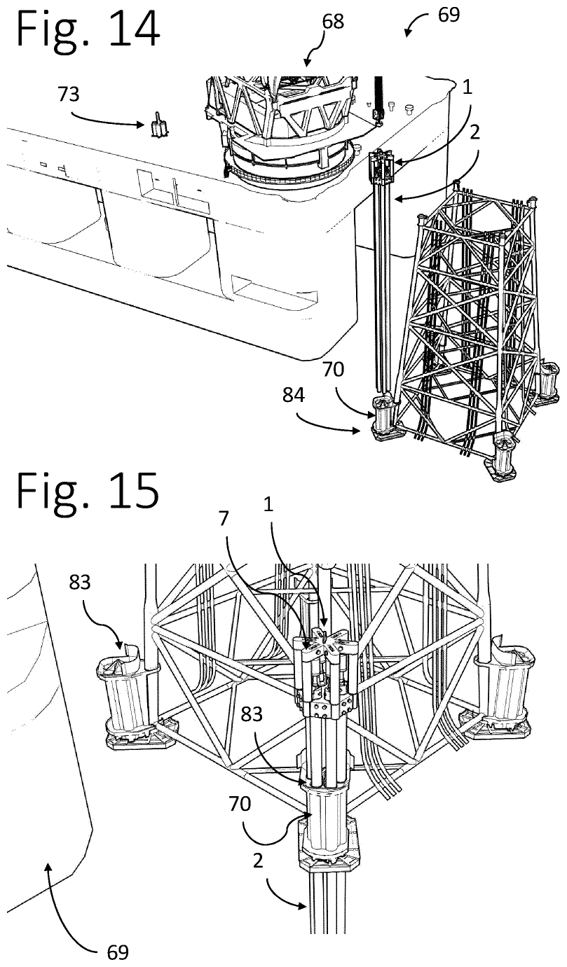

Turning to FIG. 14, the combination of the device 1 and the piles 2 is subsequently lowered into the base of a leg of a jacket 72. The base 84 comprises a base plate and pile sleeves 70 which extend upwardly from the base plate. The at least five piles are lowered into the at least five pile sleeves 70. This requires a certain degree of control and accuracy. The bottom ends of the piles are maintained at the required distance from one another by any of the temporary devices discussed above. The pile sleeves 70 may comprise tapered pile guides 83 at their upper ends to facilitate the positioning of the piles into the pile sleeves 70.

In an embodiment, the initial start-up loads can be transferred to the pile sleeves 70 by providing a rigid connection between the pile connection assemblies of the piles 2 which are under tension and the associated pile sleeves 70. This allows to be able to (partly) omit the use of ballast weight for the start-up weight during the time that limited soil capacity is activated.

It is noted that in an alternative embodiment, the piles may be positioned and lowered into the pile sleeves 70 individually and sequentially, for instance by the crane 68, and prior to the device 1 being positioned on top of the piles. Next, the device 1 is positioned on top of the at least five piles 2. In this embodiment, no pile support frame 73 is required.

When the bottom ends of the piles contact the seabed 3, initially the piles will sink into the seabed 3 under their own weight and the weight of the device 1 over a certain distance, e.g. 50 cm. Additional ballast weight may be provide on top of the device 1 to increase this distance and to improve the overall functioning of the device 1.

When all piles are inside the pile sleeves 70 and the device 1 is on top of the piles and has gripped the piles (which in top view are in polygonal configuration 5), the device 1 can start operating. The piles are alternately pushed in over a distance 18 into the ground or seabed 3 by applying a vertical force via the associated actuator 10 to the at least one pile. The device 1 may alternately push in one pile or more piles simultaneously, or any combination thereof. FIG. 15 shows the piles being pushed in the ground over a certain depth.

The bridge assembly 7 moves downward together with the piles as they are pushed into the ground.

During operation of the device 1 there are multiple options to push in the at least five piles. A few examples are described next with reference to FIGS. 16 to 27. The examples should be construed as merely exemplary and not limiting the invention. Each corner of the shown polygons 5 resembles a pile connection assembly 9 comprising an actuator 10 and a pile connector 15 which is connected to a pile 2. The exerted forces are indicated by the letter F and a corresponding number. The shown forces F1-F7 are given as example and do not take into account the weight of any installation equipment or the weight of the pile itself.

Said actuators 10 can be hydraulic cylinders, and the control device 17 may regulate a pressure in said hydraulic cylinders for exerting the vertical forces F. The hydraulic cylinder 43 may comprise a valve which can be closed in order to prevent a hydraulic medium from circulating. This way an actuator 10 can be kept substantially stationary.

FIG. 16 shows an example of a device 1 configures to push in five piles, one at each corner of the polygon, i.e. pentagon. The corners are located on the circumscribed circle 27. The pile associated with the force F1 is pushed into the ground. The force exerted on said pile is raised to 3000 mT (for example). 3000 mT is an example which is a realistic top end capacity for very dense North Sea sands, although this is of course dependent on the outer diameter and wall thickness of the pile. The vertical force on two opposite piles F3 and F4 is 927 mT which is a push force. A push force is indicated with a plus sign. The forces F2 and F5 on the associated piles are pull forces, indicated by the minus sign. There is a force equilibrium on all piles, wherein the pile associated with F1 receives a greater vertical force than each of the remaining piles. Hence, said pile F1 will be pushed downward.

The force F1 can be achieved by having the associated actuator 10 extend, by retracting the remaining actuators 10 associated with forces F2-F5, by pivoting the bridge assembly 7 about a pivot axis 23, e.g. a pivot axis 23 extending through piles F2 and F5, or by any combination thereof.

The equilibrium point 33 is located on the pivot axis. If a different force distribution is chosen, said equilibrium point may be located at a different location. This applies to all shown embodiments of FIGS. 16-26.

FIGS. 17 and 18 show different push in configurations for a six pile device 1 arranged as a hexagon.

FIG. 17 shows how one of the six piles is pushed in, namely the pile receiving force F1 of 3000 mT. The force F3 is associated with the pile opposite to the pile which is pushed in. F3 is a push force of 1000 mT. Pull forces F2 and F4 are each 2000 mT. The two piles adjacent the pile receiving the force F3 are substantially idle, or passive during this push in configuration. The force F1 can be achieved by having the associated actuator 10 extend, by retracting the remaining piles, by pivoting the bridge assembly 7 about a pivot axis 23 extending through piles F2 and F4, or by any combination thereof. The pile connection assemblies associated with each corner are arranged on circumscribed circle 27.

FIG. 18 shows the simultaneous push in of two piles associated with forces F1 and F4. All remaining piles receive a pull force F2, F3, F5, F6 of 1500 mT. This embodiment is also shown in FIGS. 3A-3C or in FIGS. 5A-5C. In FIGS. 3A-3C two piles are pushed in by extending the corresponding actuators 10. In FIGS. 5A-5C two piles are pushed in by retracting the remaining actuators 10. The force distribution can be similar in both embodiments.

Opposite loads, for example F2 and F6, do not necessarily need to be identical. When one pile experiences less soil resistance, this pile can be pushed with more ease than the opposite pile being pushed.

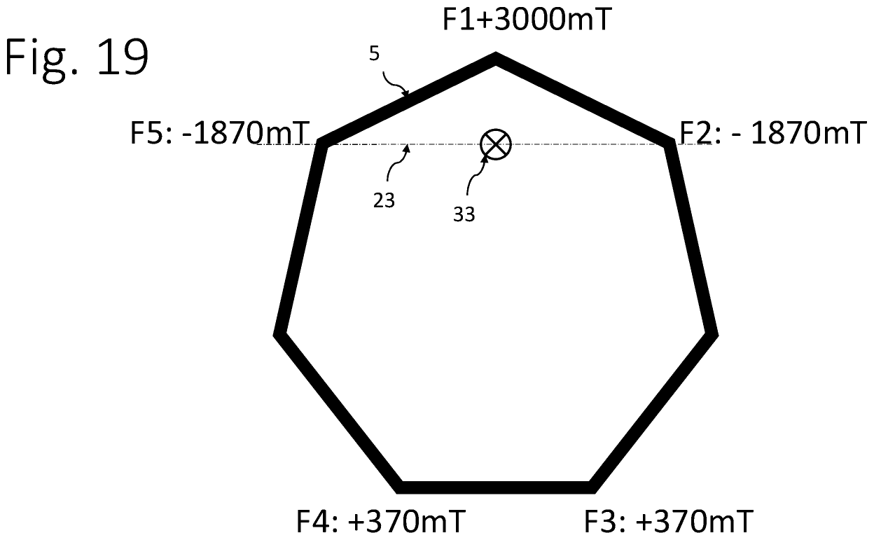

FIG. 19 shows an embodiment of a device 1 configures to push in seven piles. In the shown embodiment one pile associated with force F1 is pushed in. The device 1 is also suited to push in two piles simultaneously.

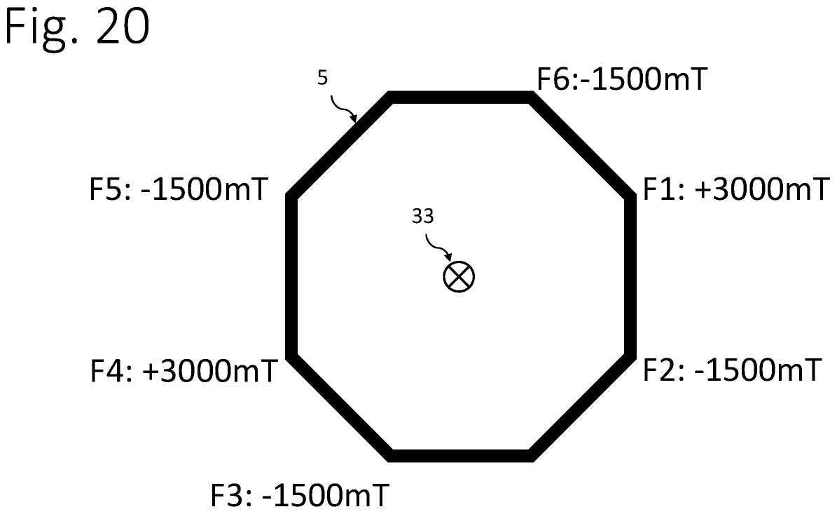

FIGS. 20-22 show an embodiment of a device 1 configured to push in eight piles, arranged in an octagon.

The push in configuration of FIG. 20 pushes in two piles simultaneously, namely the piles associated with forces F1 and F4. Four of the six remaining actuators 10 are configured to exert a vertical pull force F2, F3, F5, F6 on their associated piles.

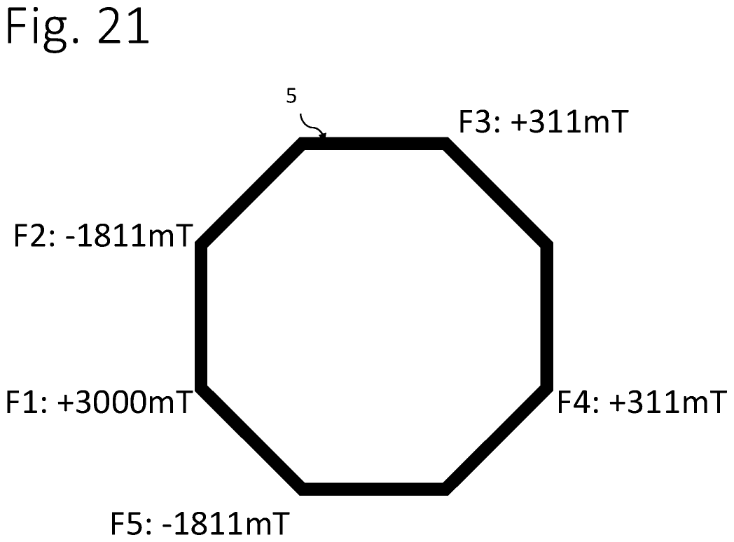

The push in configuration of FIG. 21 pushes in one pile, i.e. the pile connected to the pile connection assembly associated with force F1. Two opposite actuators 22 exert a relatively small push force F3, F4 of 311 mT to their associated piles. The opposing actuators 29 associated with vertical pull forces F2 and F5 exert a pull force of 1811 mT on their associated piles. Three piles are substantially idle in this configuration.

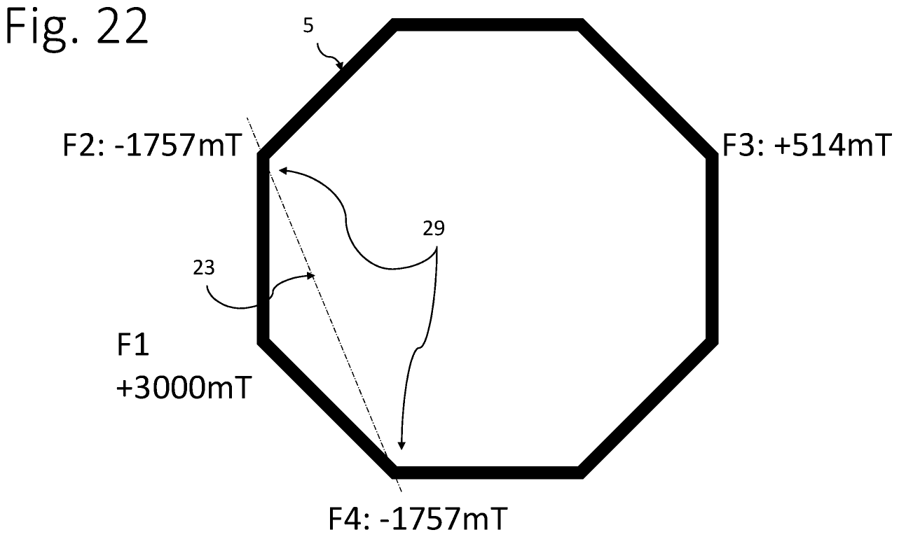

In the push in configuration of FIG. 22 four piles are substantially idle. The pile receiving push force F1 is pushed in with a vertical force of 3000 mT. The opposite actuator 10 exerts a push force F3 of 514 mT. The opposing actuators 29 adjacent the pile being pushed in exert a pull force of 1757 mT on their associated piles. The force F1 can be achieved by having the associated actuator 10 extend, by retracting the remaining piles, by pivoting the bridge assembly 7 about a pivot axis 23, e.g. extending through piles F2 and F4, or by any combination thereof.

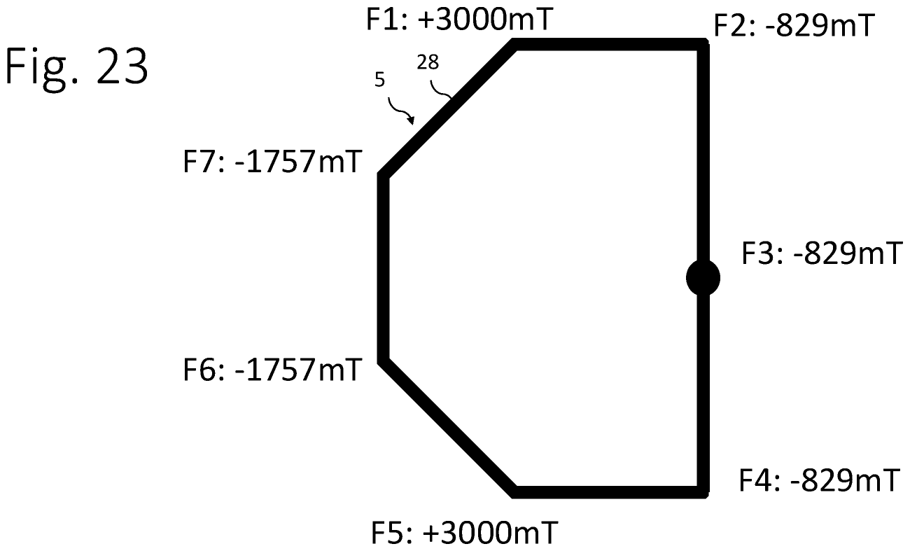

FIG. 23 shows a device 1 for pushing in seven piles, wherein the pile connection assemblies define an irregular polygon 28. The two piles associated with forces F1 and F5 are pushed in simultaneously. All remaining piles experience a pull force of either 829 mT or 1757 mT.

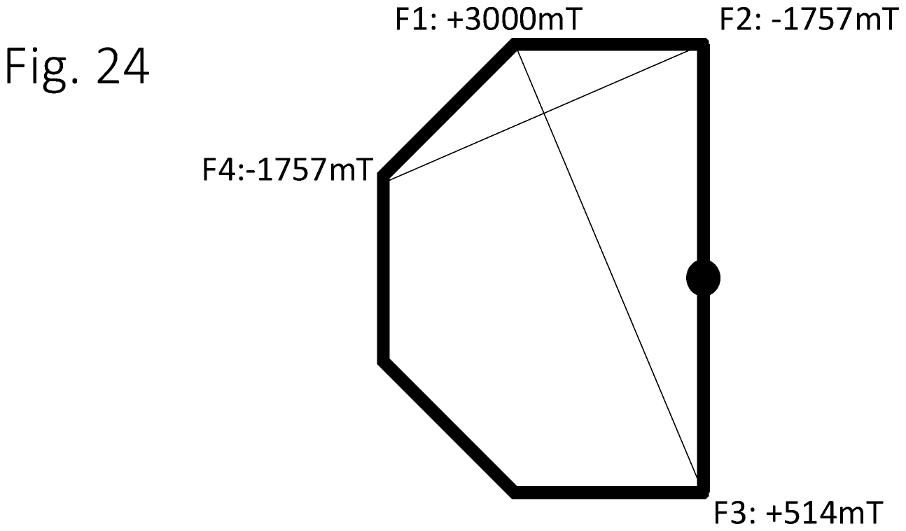

FIG. 24 shows the embodiment of FIG. 23, wherein one pile is pushed in, namely the pile receiving push force F1 of 3000 mT. The actuator 10 opposite of the pile which is being pushed in receives a push force F3 of 514 mT. Pull forces F2 and F4 are exerted by the opposing actuators 29 on the piles adjacent the pile which is being pushed in.

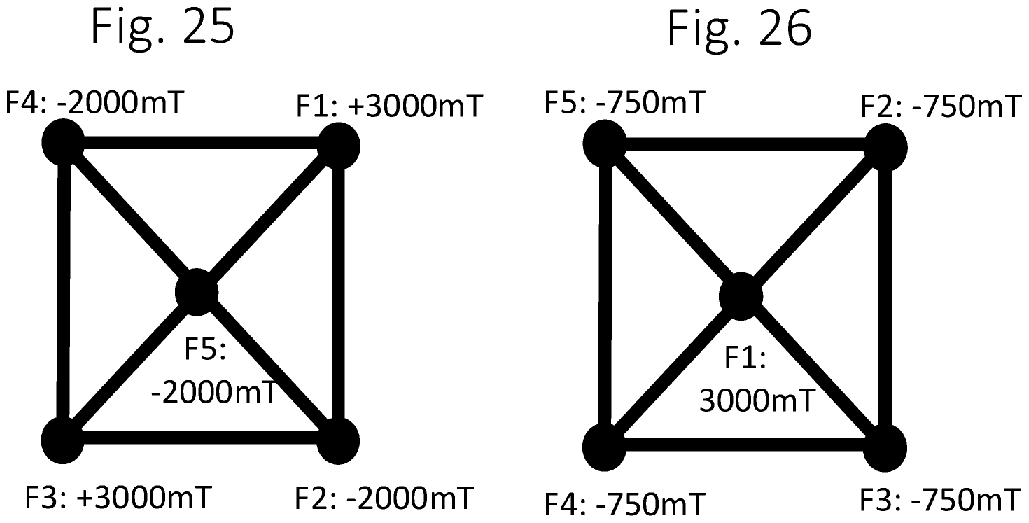

FIGS. 25 and 26 show an embodiment of the device 1 configured to push in five piles. Four of the five piles define the polygonal configuration 5, i.e. F1 to F4. One remaining pile, F5, is located within the polygon. In this embodiment, a difference in forces between the piles which are pushed in is transferred as a bending moment in other piles via the bridge assembly 7.

In FIG. 25 two piles are pushed in simultaneously, namely the piles associated with vertical push forces F1 and F3. The remaining actuators 10 exert a pull force F2, F4, F5 on their associated piles.

In the configuration of FIG. 26 the middle pile is pushed in by a push force F1 of 3000 mT. The four remaining piles experience a pull force F2-F5 of 750 mT via their associated actuators 10.

During operation the device 1 may carry out a cycle. A cycle may comprise in sequence:
pushing the first pile 2.1 over a distance 18 into the ground or seabed 3,
pushing the second pile 2.2 over a distance 18 into the ground or seabed 3,
pushing the third pile 2.3 over a distance 18 into the ground or seabed 3,
pushing the fourth pile 2.4 over a distance 18 into the ground or seabed 3,
pushing the fifth pile 2.5 over a distance 18 into the ground or seabed 3.

If there are more than five piles to be pushed in, each cycle further comprises pushing any subsequent pile over a distance 18 into the ground or seabed 3.

A cycle may also comprise in sequence:
pushing the first pile 2.1 and second pile 2.2 simultaneously over a distance 18 into the ground or seabed 3,
pushing the third pile 2.3 and fourth pile 2.4 simultaneously over a distance 18 into the ground or seabed 3,
pushing the fifth pile 2.5 and sixth pile 2.6 simultaneously over a distance 18 into the ground or seabed 3.

If more than six piles, each cycle comprises pushing any subsequent pairs of piles over a distance 18 into the ground or seabed 3.

The cycles of pushing in one pile and two piles may also be combined, both sequentially as internally. It may also be possible to push in groups of three piles or more into the ground simultaneously.

In an advantageous embodiment, the first step or the last step of the cycle comprises keeping at least one or two actuators 10 substantially stationary while retracting the remaining actuators 10 for pushing the at least one or two piles corresponding to the at least one or two substantially stationary actuators 10 into the ground or seabed 3. The other steps comprise extending the at least one or two actuators 10 for pushing the at least one or two piles corresponding to the at least one or two actuators 10 into the ground or seabed 3.

As the device 1 is also configured to pull out at least five piles, the cycle to do so is in essence the same as pushing in at least five piles, but reversed.

A method for pulling out the at least five piles 2 comprises the steps:
connecting the device 1 according to the first aspect of the invention to the upper ends of the piles, wherein each pile connection assembly 9 is connected to an associated pile 2,
alternately pulling at least one of the piles over a distance out of the ground or seabed by alternately
   retracting the at least one or at least two actuators 10 which are associated with the at least one or at least two piles 2, and/or by
   keeping at least one or at least two actuators 10 associated with the at least one or at least two piles being pulled out substantially stationary while extending at least three or at least four of the remaining actuators, and/or by
   keeping at least one or at least two actuators associated with the at least one or at least two piles being pulled out substantially stationary while retracting at least two opposite actuators, thereby pivoting the bridge assembly about a pivot axis 23 extending between said at least one actuator and said at least two opposite actuators.

### Second Aspect

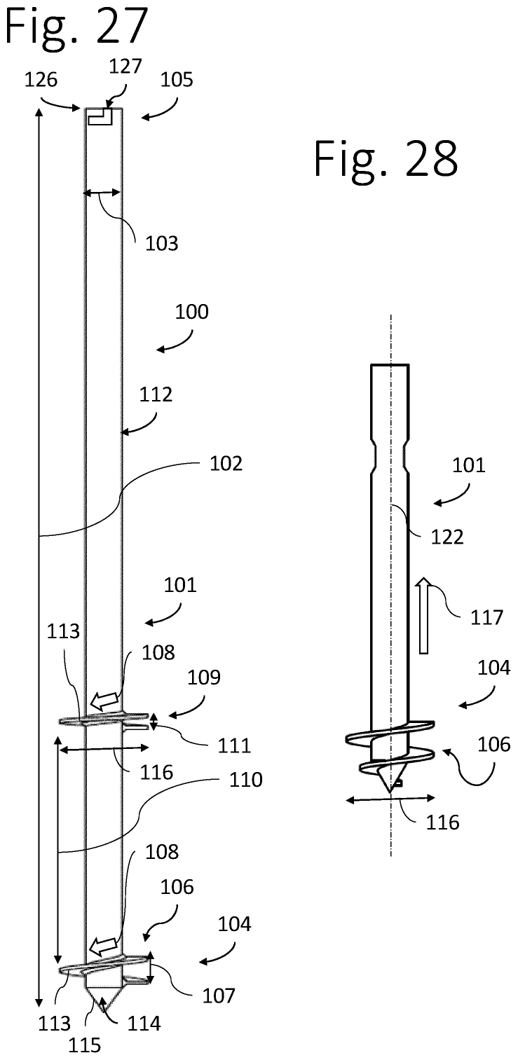

Turning to FIG. 27, a side view of an embodiment of a helical pile 100 according to a second aspect of the invention is shown, namely a helical pile 100 for installation into the ground or seabed 3.

The helical pile 100 comprises a first tubular section 101 having a length 102 and a first outer diameter 103. The first tubular section 101 comprises a first end 104 and an opposite, second end 105. The first end 104 is configured to be inserted into the ground or seabed 3.

The helical pile 100 comprises a first helical section 106 which is provided between the first end 104 and second end 105. In the shown embodiments the first helical section 106 is provided at the first end 104. The first helical section 106 has a first pitch 107 and a first pitch orientation 108. The first pitch orientation 108 is the direction of the helical section as it extends around the first tubular section 101 from the second end 105 toward the first end 104, when seen in top view. In FIG. 27 the first pitch orientation 108 is clockwise 134.

The helical pile 100 comprises a second helical section 109 which is provided between the first helical section 106 and the second end 105 at a distance 110 from the first helical section 106. The second helical section 109 has a second pitch 111 and the same first pitch orientation 108 as the first helical section 106.

The second pitch 111 is different from the first pitch 107.

The second pitch 111 is smaller than the first pitch 107.

The first outer diameter 103 is constant between the first helical section 106 and the second helical section 109. The first outer diameter 103 may however also vary.

The distance between the first helical section 106 and the second helical section 109 is preferably at least 3 times the first outer diameter 103.

The first helical section 106 extends away from an outer surface 112 of the first tubular section 101. The first helical section 106 is provided on said outer surface 232 112.

The second helical section 109 extends away from the outer surface 112 of the first tubular section 101. The second helical section 109 is provided on said outer surface 112.

The first helical section 106 and the second helical section 109 comprise a helical plate 113, i.e. a plate which extends as a helix around the first tubular section 101.

The first end 104 comprises a penetrating section 114 configured to penetrate the soil. Said penetrating section 114 can have different shapes. A shape which is shown is a conical shape 115 converging from the first end 104.

An outer diameter 116 of the first and/or second helical section 109 may be at least 1.5 times the first outer diameter 103. In FIG. 27 the outer diameters 116 of the first and second helical sections 106, 109 are constant and identical to each other.

FIG. 28 schematically shows a side view of another embodiment of the first helical section 106. A lower part is shown of the first tubular section 101 comprising the first helical section 106. An outer diameter 116 of the first helical section 106 increases in a direction 117 from the first end 104 towards the second end 105. Also an outer diameter 116 of the second helical section 109 may increase in this way. This provides a smoother penetrating of the helical sections into the ground or seabed 3 during the rotation of the pile about its longitudinal axis 122.

The helical section of FIG. 28 extends more than one rotation about the pile. The first and second helical sections 106, 109 of the embodiment of FIG. 27 extend one rotation about the pile.

The first helical section and second helical section of the embodiment as shown in FIG. 27 comprise a single helix, i.e. a helix with one rotation. Rotations may also be called turns, or circumvolutions. The embodiment of FIG. 28 shows an embodiment in which the helical sections comprise a helix 106 with two rotations. In general the helical sections have a helix with less than three full rotations, or turns. A rotation of three or more would result in a too high frictional resistance. A higher frictional resistance requires more force and therefore higher loads on the installation equipment and on the pile.

The helical pile 100 of FIG. 27 has a substantially constant first outer diameter 103.

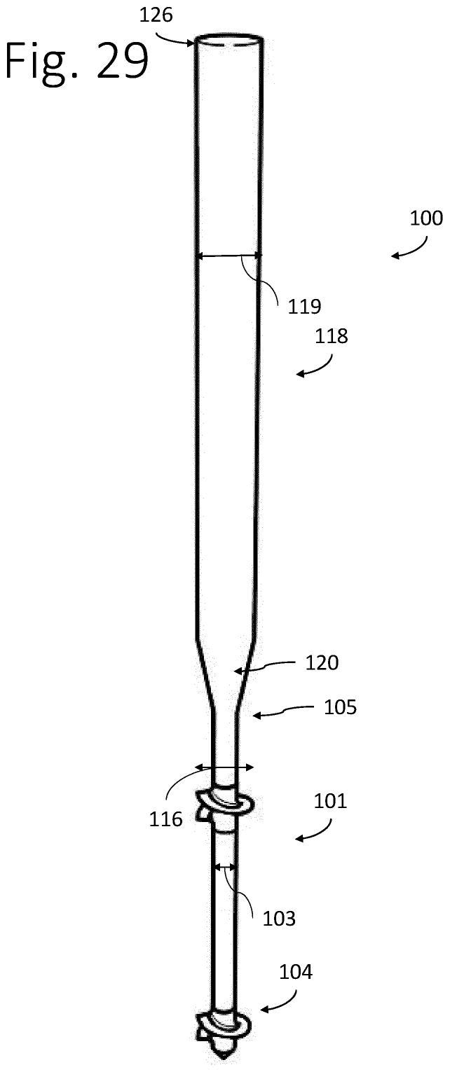

In a different embodiment, as shown in the perspective view of FIG. 29, the helical pile 100 comprises a second tubular section 118 connected to the second end 105. The second tubular section 118 has a second outer diameter 119 which is larger than the first outer diameter 103.

The outer diameter 116 of the first and second helical sections 106, 109 is equal to or smaller than the second outer diameter 119. This embodiment allows the helical pile 100 to be inserted through sleeves having an opening diameter close to, but at least minimally larger than the second outer diameter 119, while providing an effective screw in effect.

The first tubular section 101 and the second tubular section 118 are connected via a tapered section 120 at their respective ends. The connection between the first tubular section and second tubular section may also be other than a tapered section, for example a stepped increase.

The longitudinal axis of the second tubular section coincides with the longitudinal axis of the first tubular section.

The first helical section 106 and/or the second helical section 109 of the embodiments in FIGS. 27 and 29 are a circular helix, i.e. one with constant radius.

The first helical section 106 of the embodiment of FIG. 28 is a conic helix at the tip, and then gradually goes over into a circular helix.

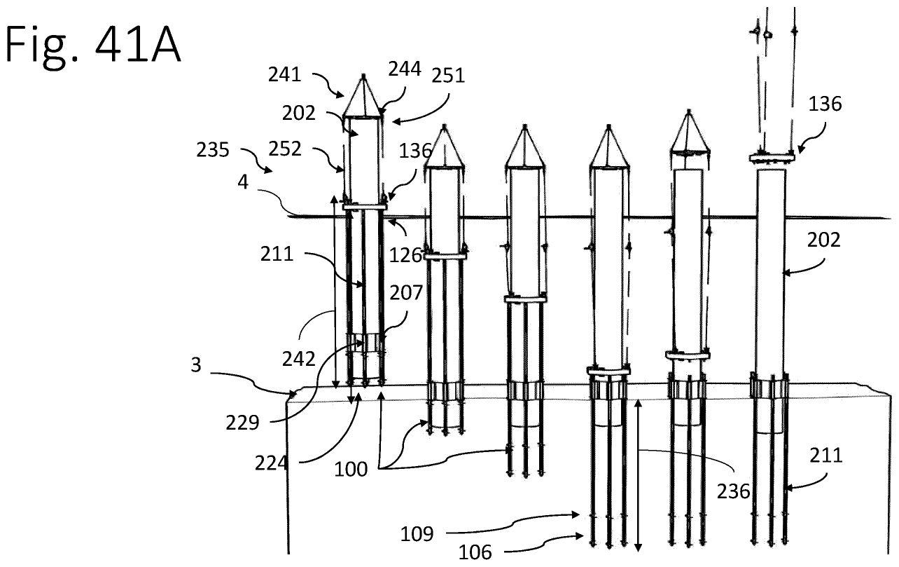

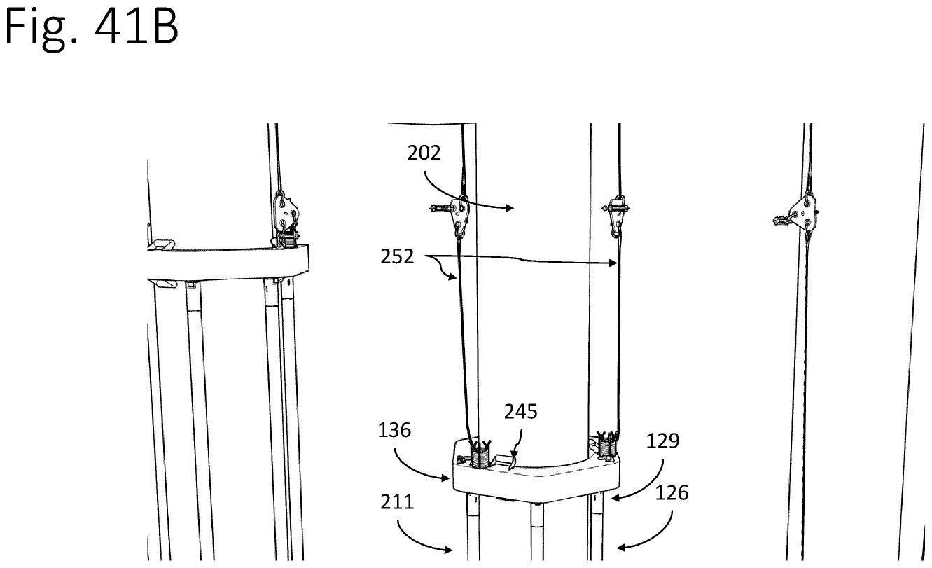

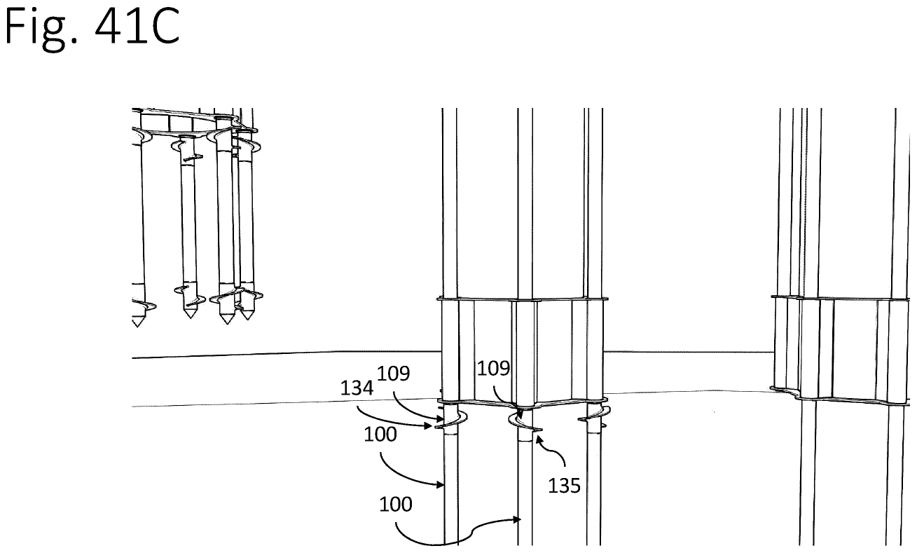

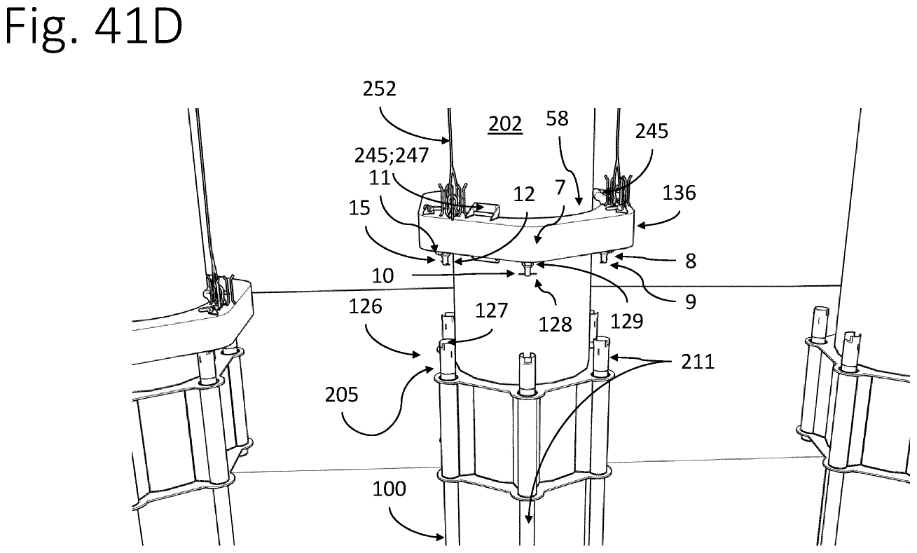

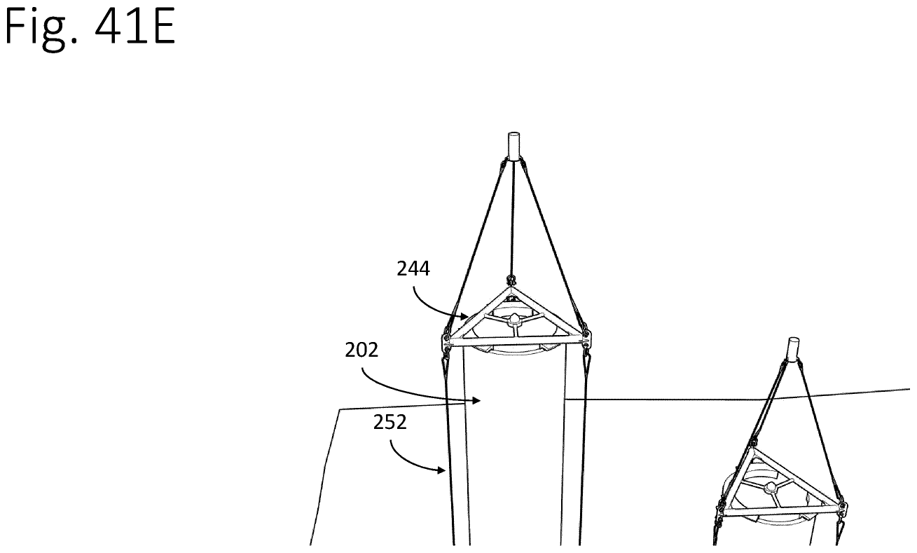

The top end 126 of the helical pile 100 may comprises a female mating part 127 configured to be engaged by a male mating part 128 of a pile connector 15 associated with a rotating actuator 129 for rotating the pile about its longitudinal axis 122, or vice versa. This is shown in FIG. 41D, wherein the top end 126 of the helical pile 100 comprises a slot like a slotted screw.

FIG. 27 shows another embodiment of the female mating part 127, namely a bayonet female part configured to provide bayonet coupling with the male part 128 of the rotating actuator 129.

### Operation

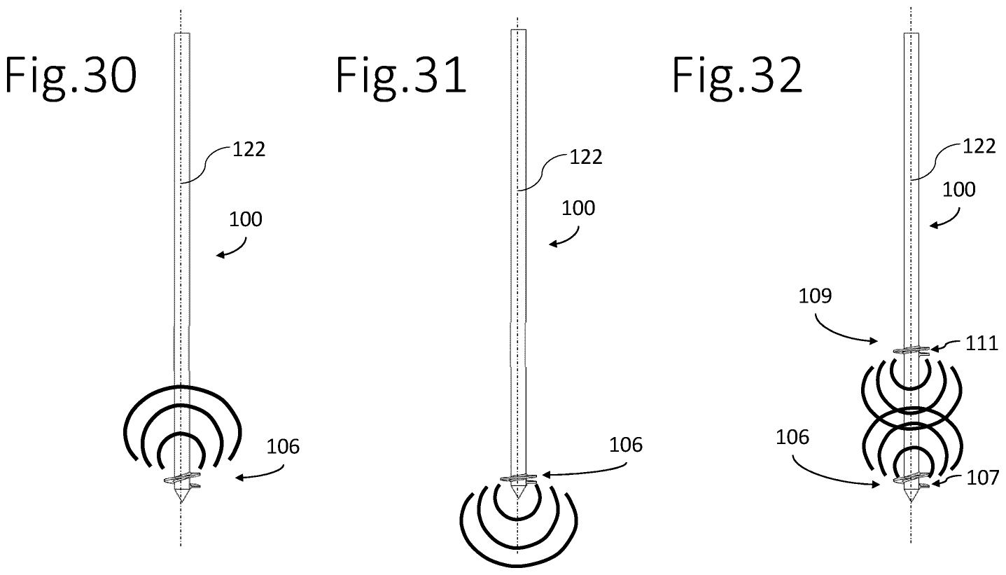

Turning to FIGS. 30 and 31, two installation concepts are shown for a helical pile 100 comprising a single helical section 106 having a pitch and pitch orientation.

FIG. 30 schematically shows the concept of ‘self-weight’ installation. During self-weight installation the vertical pressure on the pile is kept substantially constant. The pile screws itself down. It however takes more than one rotation of the pile about its longitudinal axis 122 to move the pile down one pitch associated with the helical section. The ratio between the rotations of the pile and the amount of pitches the pile moves down because of those rotations is higher than one. This results in an increase of soil stress above the helical section, because soil is moved upwards by the helical section. A larger tension capacity is achieved with this type of installation, which is beneficial when a higher uplift capacity is desired.

FIG. 31 schematically shows the concept of ‘pitch-matched’ installation. During ‘pitch-matched’ installation the pile 100 is moved exactly one pitch of the helical section downwards per rotation of the pile. In order to achieve this an axial force has to be applied to the pile. The axial force leads to an increase of the compressive capacity, because the soil below the helical section is pre-loaded during installation. A higher compressive capacity may be beneficial, because it leads to a higher bearing capacity of the pile.

The helical pile 100 according to the invention is configured to advantageously combine both installation concepts. That is when the second pitch 111 of the second helical section 109 is different from the first pitch 107 of the first helical section 106, in particular when the second pitch 111 is smaller than the first pitch 107. This is schematically shown in FIG. 32, wherein the ‘self-weight’ installation concept and the ‘pitch-matched’ concept are combined.

The pile of FIG. 32 is the same helical pile 100 as FIG. 27, except for the bayonet coupling 130. The first helical section 106 has a first pitch 107 which is greater than the second pitch 111 of the second helical section 109.

The helical pile 100 is installed in such a way that the first helical section 106 makes use of the self-weight concept and the second helical section 109 makes use of the pitch-matched concept. This way the soil between the two helical sections is activated in order to provide both a higher tension capacity and a higher compressive capacity.

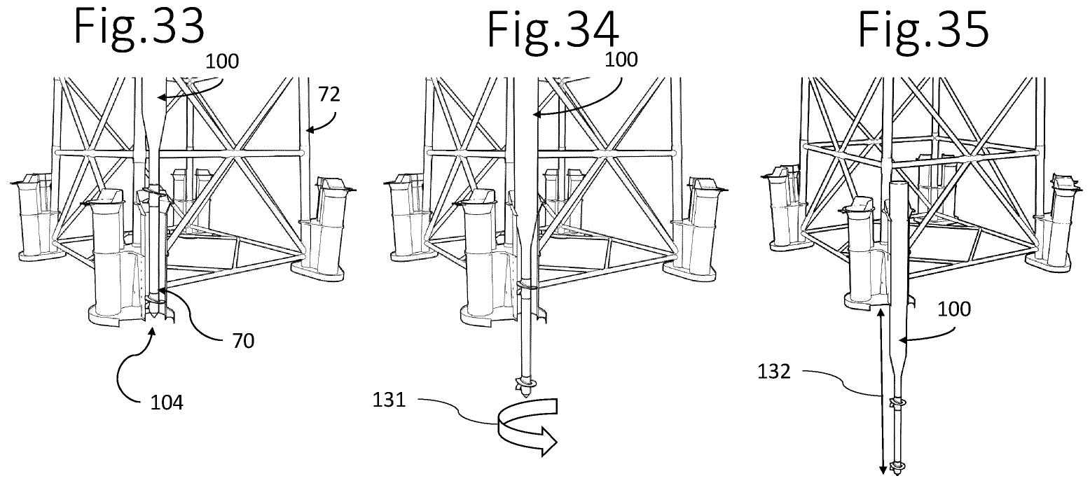

Turning to FIGS. 33 to 35, a method is shown for installing the helical pile 100 according to the second aspect of the invention. The helical pile as shown in FIG. 29 is used. In the shown embodiment the helical pile 100 is installed through a sleeve 70 at a bottom of a jacket 72 structure. The helical pile 100 can however be used in combination with other structures as well.

The method comprises
positioning the helical pile 100 on the ground or the seabed 3 in an upright orientation, wherein the first end 104 is in contact with the ground or the seabed 3, and wherein the first helical section 106 engages the ground or the seabed 3, as shown in FIG. 33,
moving the helical pile 100 into the ground by rotating the helical pile 100 about its longitudinal axis 122 in a direction 131 corresponding with the first pitch orientation 108 of the helical sections, until the first helical section 106 and the second helical section 109 are both located at a predetermined distance 132 below the ground or seabed 3, as shown in FIGS. 34 and 35.
connecting a structure to the installed helical pile 100, wherein the installed helical pile 100 forms a foundation or part of a foundation of said structure 72 and transfers horizontal and/or vertical loads which are exerted by the structure 72 onto the installed helical pile to the surrounding soil.

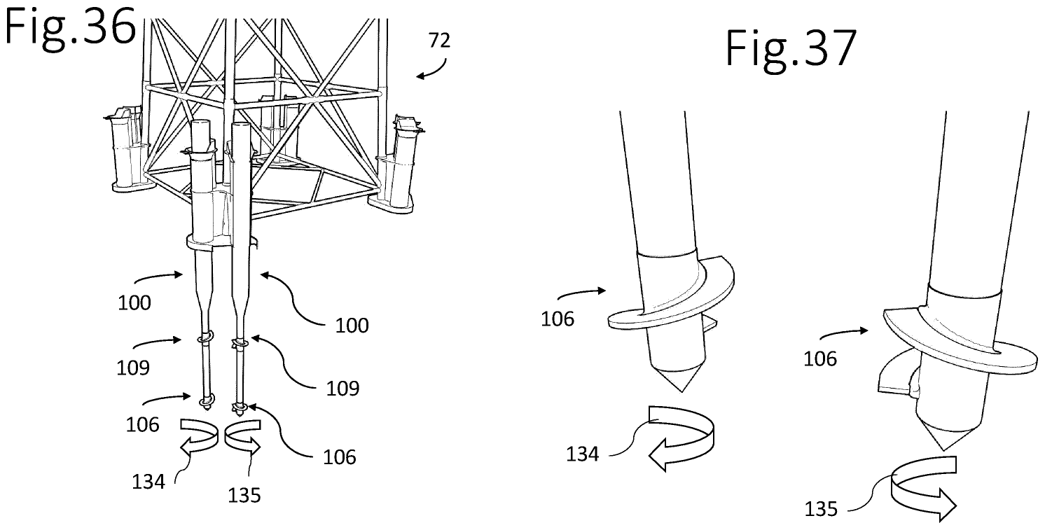

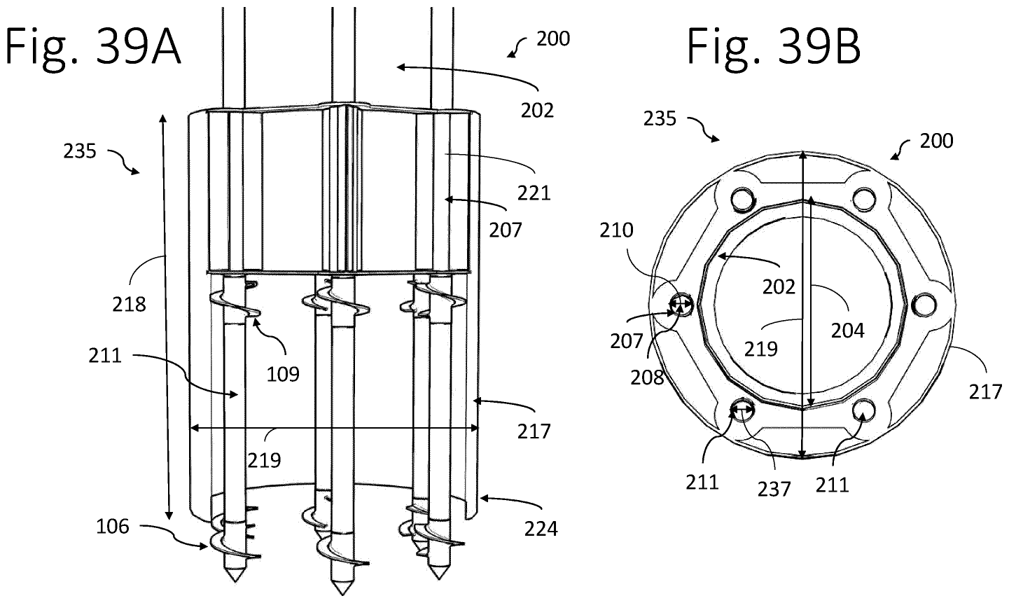

The structure 72 may for example be a jacket structure 72, as shown in FIG. 36, or a support structure 200 as shown in FIG. 39A.

The pile is moved downward into the ground or seabed 3 over a distance equal to M times the first pitch 107 of the first helical section 106 by completely rotating the helical pile 100 N times about its longitudinal axis 122, wherein N is greater than M. This way the first helical section 106 is installed using the self-weight concept, while the second helical section 109 is installed using the pitch-matched concept. The first helical section 106 in a way pulls the second helical section 109 down, thereby providing the required axial force for the pitch-matched concept of the second helical section 109.

The method is rather effective when the second pitch 111 is M/N times the first pitch 107, because that results in a relatively high activation of the soil between the first helical section 106 and the second helical section 109.

FIGS. 36 and 37 schematically show a step of a method for installing at least two helical piles 100 according to the second aspect of the invention simultaneously. For this method a first helical pile 100, here the left one, comprises helical sections 106, 109 with a clockwise first pitch orientation 108 when seen in top view. A second helical pile 100, here the right one, comprises helical sections with a counter clockwise first pitch orientation 108 when seen in top view.

The method comprises positioning the helical piles 100 on the ground or the seabed 3 in an upright orientation, wherein the first ends 104 are in contact with the ground or the seabed 3, and wherein the first helical sections 106 engages the ground or the seabed 3

An installation device 136 as shown in for example FIG. 41D is provided. The installation device 136 comprises a bridge assembly 7 which when seen in top view defines at least two connecting locations 8. The installation device 136 has at least two pile connection assemblies via which in use each of the at least two helical piles 100 is connected to the bridge assembly 7.

Each pile connection assembly comprises a rotating actuator 129 configured to rotate in a clockwise 134 and/or a counter clockwise 135 direction relative to the bridge assembly 7 when seen in top view.

The pile connection assembly comprises a pile connector 15 which is connected to the rotating actuator 129. Each pile connector 15 is configured to be connected to an upper part 16 of a helical pile 100 which is to be moved into the ground or seabed 3. The pile connector 15 is configured to be rotated by the associated rotating actuator 129.

The method further comprises connecting a first pile connector 15 of the installation device 136 to the first helical pile 100 and a second pile connector 15 of the installation device 136 to the second helical pile 100. Connecting the pile connectors 15 to the helical piles 100 may be done prior to positioning the helical piles 100 on the ground or seabed 3.

Next the first, left helical pile 100 is rotated in the clockwise 134 pitch orientation via the second pile connector 145 and the associated actuators 129 simultaneously rotates the second, right helical pile 100 in the counter clockwise 135 direction via the second pile connector 146 and the associated actuator 129. By having counter rotating actuator 129 the torque loads exerted on the piles and the installation device 136 are balanced.

The helical piles 100 may be moved downward into the ground or seabed 3 over a distance equal to M times the first pitch 107 of the first helical section 106 by completely rotating the helical pile 100 N times about its longitudinal axis 122, wherein N is greater than M.

The present invention further provides a method for removing an installed helical pile 100 according to the invention from the ground or seabed 3, the method comprising the step of rotating the pile in a direction opposite to the first pitch orientation 108 of the helical sections.

It is also possible to remove at least two installed helical piles 100 simultaneously, wherein a first helical pile 100 comprises helical sections in a clockwise 134 pitch orientation when seen in top view, and wherein a second helical pile 100 comprises helical sections in a counter clockwise 135 pitch orientation when seen in top view.

The method comprising the steps of connecting the installation device 136 to the at least two piles by connecting the second pile connector 145 to the first helical pile 100 and the second pile connector 146 to the second helical pile 100.

Next the first helical pile 100 is rotated in the counter clockwise 135 pitch orientation via the second pile connector 145 and the associated actuator 10 and the second helical pile 100 is rotated simultaneously in the clockwise 134 direction via the second pile connector 146 and the associated actuator 10.

An advantage of counter rotating two helical piles 100 is that less residual moment is transferred to the surrounding, be it the vessel 69 operating the tool, the foundation itself or the piles 100 themselves or any combination thereof.

To prevent that one helical pile 100 moves into the ground substantially faster than the other, speed can be controlled while keeping the torque as close as possible to the one that needs to catch up. This is easiest when using electric motors, typically equipped with an additional gearbox, where a setting can be chosen as max torque, (close to) zero speed. Hydraulic motors can also be used. These however require more complex steering of the moments along with the speed to account for the differences.

### Third Aspect

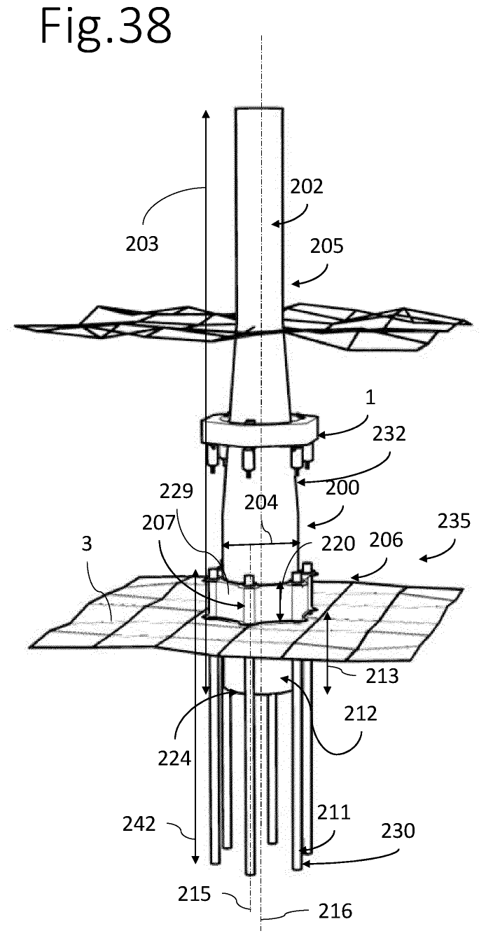

Turning to FIG. 38 a third aspect of the invention is shown, a support structure 200 for supporting a top structure above the ground or a seabed 3. The top structure can be for example a wind turbine.

The support structure 200 comprises at least one support pile 202 having a length 203 and a first outer diameter 204. In the shown embodiments a single support pile 202 is shown.

The support pile 202 comprises an upper part 205 which is configured and intended to extend above the ground or the seabed 3. The upper part 205 of the support pile 202 is configured to be connected to the top structure.

The support pile 202 is configured to exert an upward vertical force on the top structure in order to carry the top structure.

A lower part 206 of the at least one support pile 202 is in contact with the ground or seabed 3. The lower part 206 may rest on the ground or seabed 3. When the lower part 206 rests on the seabed, there is less lateral resistance.

In the shown embodiment a bottom part 212 of the lower part 206 extends over a distance 213 into the seabed 3. An advantage of this embodiment is that the bottom part 212 of the support pile 202 which extends into the ground provides lateral capacity to the support structure 200. As the support pile 202 takes over at least a part of the lateral capacity from the foundation piles 211, the foundation piles 211 may have a smaller diameter. A smaller diameter of the foundation piles 211 in turn requires a lower installation force for the foundation piles 211.

The lower part 206 of the support pile 202 may be configured to extend into the ground or seabed 3 by a distance of at least one time the first outer diameter 204 of the support pile 202.

The support pile 202 comprises a plurality of foundation guides 207 which are connected to the lower part 206 of the at least one support pile 202. The embodiment of FIG. 38 has six foundation guides 207. Each foundation guide 207 has an opening 208 (FIG. 39B) extending in a direction of the at least one support pile 202. The direction of the opening may also be angled with respect to the support pile 202. The opening has an opening diameter 210. Each foundation guide 207 accommodates a foundation pile 211, wherein the foundation pile 211 extends through the foundation guide 207 and at least partly into the ground or the seabed 3.

The foundation guides 207 are configured to receive a vertical force from the foundation piles 211.

The support structure 200 comprises at least three foundation guides 207.

When the support pile 202 is configured to extend into the ground or seabed 3, the foundation guides 207 are typically provided at a distance 213 above a bottom end 224 of the at least one support pile 202.

A longitudinal axis 215 of the opening of the foundation guides 207 may extend parallel to a central axis 216 of the at least one support pile 202.

In top view the foundation guides 207 are arranged around the at least one support pile 202.

In said top view the foundation guides 207 may be arranged equidistantly around the at least one support pile 202, see for example the embodiment of FIG. 39B.

A length 220 of the foundation guide 207 may be at least twice the opening diameter 210 of the opening of the foundation guide.

The opening diameter 210 of the foundation guides 207 is smaller than the first outer diameter 204, in particular at least 3 times smaller.

In the shown embodiment, the foundation guides 207 are sleeves 221.

The opening of the foundation guide 207 is located at less than 2 times the opening diameter 210 away from an outer surface 232 of the at least one support pile 202, in particular less than once the opening diameter 210. This allows for a compact support structure 200, and subsequently for a compact support assembly 235.

The foundation guides 207 are connected to each other via a foundation frame 229. The foundation frame 229 is connected to and extends around the support pile 202. The foundation frame 229 provides stiffness to the connection between the foundation guides 207 and the at least one support pile 202. The support pile 202 usually is a slender structure having a relatively high diameter of wall thickness ratio. This lead to a behaviour like a soda can, i.e. the wall of the support pile 202 has a low resistance to radial forces. Hence, the foundation frame 229 is provided for additional stiffness.

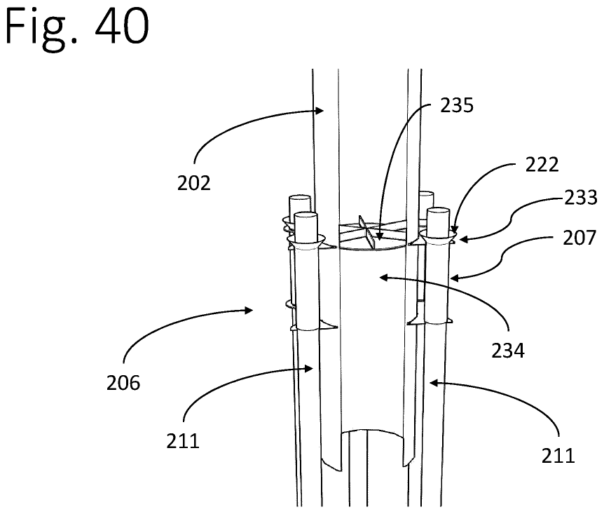

The foundation guides 207 may comprise a centering member 222 around the opening at the top end 223 thereof, as shown in for example FIG. 40. The centering member 222 is configured to center and guide a bottom end 230 of a foundation pile 211 into the opening of the foundation guide.

FIGS. 39A and 39B schematically show an embodiment wherein the support pile 202 comprises a widening part 217 which extends over a distance 218 upwards from the bottom end 224. The widening part 217 is configured to extend into the ground or seabed 3. The widening part 217 has a second outer diameter 219 which is greater than the first outer diameter 237 204 116 103. In the top view of FIG. 39B it is shown that the foundation guides 207 extend outside the first outer diameter 204 and inside the widening part 217 having the second outer diameter 219. The widening part 217 provides additional lateral capacity to the support structure 200.

FIG. 40 shows an embodiment of the support structure 200, wherein a suction bucket 234 is provided inside the lower part 206 of the support pile 202. The suction bucket 234 comprises a reinforced plate 235. The suction bucket is configured to be connected to a pump for providing under pressure inside the suction bucket 234 for moving the lower part 206 of the support pile 202 into the ground or the seabed 3 via suction or at least partly via suction.

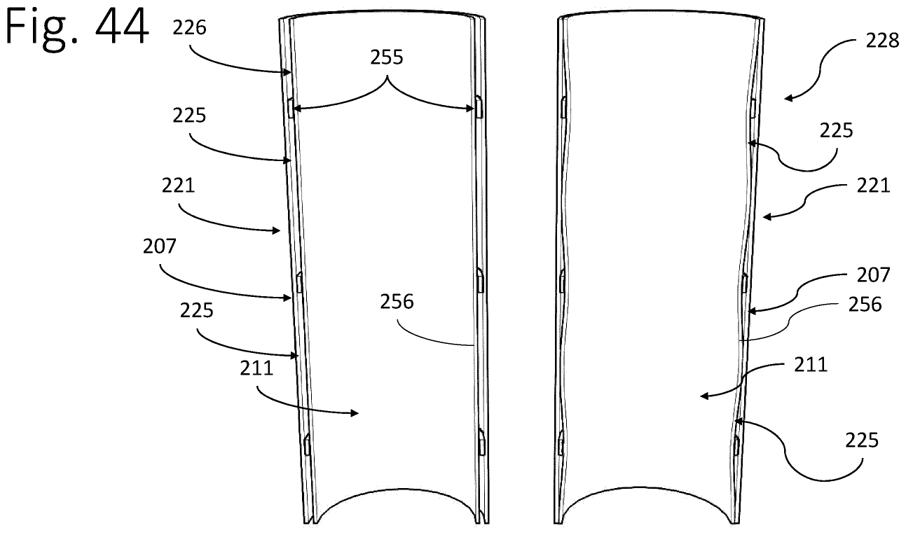

At least one annular recess 225 is provided in an inner side 226 of the sleeve 221, the annular recess 225 being configured and intended to form a female part 227 of a swaging connection 228 between the foundation pile 211 and the sleeve 221, see FIG. 44.

The support structure 200 is part of a support assembly 235 according to another aspect of the invention for supporting a top structure above the ground or a seabed 3. The top structure may for example be a wind turbine. An embodiment of the support assembly 235 is shown in FIG. 38.

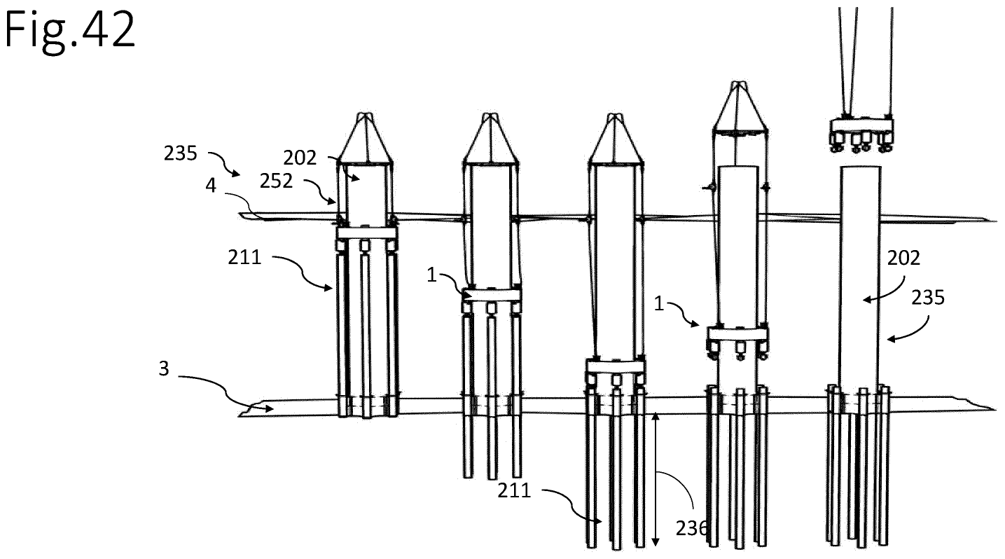

The support assembly 235 comprises a plurality of foundation piles 211, in particular at least three. Each foundation pile 211 extends through a respective foundation guide 207 and is configured and intended to extend at least partly into the ground or the seabed 3 over a foundation depth 236 (FIG. 42). When installed the foundation piles 211 provide resistance against overturning of the support pile 202, as well as lateral resistance.

The foundation piles 211 are arranged around the first outer diameter 204, i.e. around the outer surface 232 of the at least one support pile 202.

The first outer diameter 204 of the support pile 202 is greater than an outer diameter 237 of the foundation piles 211 (FIG. 39B), for example at least three times greater.

The foundation piles 211 may have the same outer diameter 237.

The foundation piles 211 are arranged equidistantly around the support pile 202. In a preferred embodiment the foundation piles 211 define a cyclic polygon 24 when seen in top view, see for example FIG. 39B. Also the foundation piles 211 of FIG. 40 define a cyclic polygon 24 of four in top view.

One or more of the foundation piles 211 may comprises at least one helical section at a lower end thereof extending around the outer surface 232, as shown in the embodiment of FIG. 39A. The foundation pile 211 with here two helical sections 106, 109 is configured to be rotated about its longitudinal axis in order to move the foundation pile 211 into the ground or the seabed 3. The helices of all piles in the embodiment of FIG. 39A have a counter clockwise pitch orientation when seen in top view. Also the first pitch 107 and the second pitch 111 of the helical foundation piles 211 are substantially the same.

Helical piles 100 according to the second aspect of the invention may also be advantageously used as foundation piles 211. Also a combination of helical piles 100 and piles without helices may be used.

Prior to installation of the support assembly 235, the foundation piles 211 may located adjacent the support pile 202. At least 80 percent of the length 242 of the foundation piles 211 are located adjacent the support pile 202. In the shown embodiment of FIG. 41, the foundation piles 211 overlap the support pile 202 with more than 90 percent of their length 242. An advantage of the support assembly 235 is that the support pile 202 can be of shorter length 203 compared to a monopile offering the same lateral and overturning capacity. The foundation piles 211 provide a telescopic effect, so that the total length 203 of the support assembly 235 prior to installation is much shorter than a monopile. The shorter length 203 is beneficial for storage and transport, because the support assembly 235 is easier to store and transport vertically compared to a monopile, which is typically transported horizontally.

After installation of the support assembly 235 at least 60 percent of the length 242 of the foundation piles 211 extends below the support pile 202.

The invention further provides a floating vessel 69 comprising at least one support assembly 235. During transport the at least one support assembly 235 is provided on the vessel 69, in particular on a deck 78 of the floating vessel 69, in a vertical orientation.

A benefit of the support assembly 235 is that when provided with the foundation frame 229 the bottom of the support structure 200 has strong points to allow for vertical transport. Where a typical monopile has a relatively weak bottom section consisting only of a thin walled tubular, the present invention has sufficient strength and stiffness at the bottom to be able to support the assembly in a vertical position while subjected to the motions and the resulting accelerations during marine transport.

### Operation

Methods for installing different embodiments of the support assembly 235 into the seabed 3 below a waterline 4 are shown in FIGS. 41 to 44.

FIG. 41A shows an embodiment of a method for installing a support assembly 235 wherein helical piles 100 are used as foundation piles 211. The method is shown from left to right.

The method comprises positioning the support pile 202 with its bottom end 224 on the ground or the seabed 3. In this embodiment the foundation piles 211 extend through the foundation guides 207 in the form of sleeves and are located adjacent the support pile 202 during lowering of the support assembly 235. The outer diameter of the helical sections is greater than the opening diameter of the foundation guides. This way, the support pile rests on the helical sections 106, 109 of the foundation piles via the foundation guides during lowering.

The foundation piles 211 are connected at their top ends 126 to pile connectors 15 of an installation device 136 for moving the foundation piles 211 into the seabed 3. The installation device 136 is part of a lowering assembly 241 and is connected to a lowering frame 244 above the top end 251 of the support pile 202 via cables 252. See FIG. 41E for an example of the lowering frame 244. The distance between the lowering frame and the installation device 136 can be altered by altering the length of the cables. The lowering assembly 241 is typically connected to a crane 68 on board an installation vessel 69. The crane 68 moves the lowering assembly 241 and thereby the support assembly 235 down to the seabed 3.

Next a part of the lower part 206 of the support pile 202 is moved into the seabed 3.

The foundation piles 211 are in this embodiment already located in the foundation guides 207 and on the seabed 3. The foundation piles 211 may also be positioned in the foundation guides 207 and on the seabed 3 after the support pile 202 is positioned on the seabed 3.

Next the foundation piles 211 are moved into the ground or the seabed 3 over the foundation depth 236 by the installation device 136. Here the foundation piles 211 are helical piles 100. Hence the installation device 136 rotates the helical piles 100 in order to move them down. During this step the cables by which the installation device 136 is connected to the lowering frame are slacked, as shown in FIG. 41B. This way, the weight of the installation device 136 provides an additional downwards force on the foundation piles 211 which may assist the installation thereof.

When the foundation piles 211 have reached their foundation depth 236, or predetermined penetrating depth, the installation device 136 is disconnected from the foundation piles 211 and subsequently moved upward relative to the support pile 202 and away therefrom. This is depicted in the two steps on the right of FIG. 41A and in FIG. 41D.

Turning to FIG. 41D, the installation device 136, which is suited for installing helical piles 100, comprises a bridge assembly 7 which when seen in top view defines a plurality of connecting locations 8 corresponding to the plurality of foundation piles 211. The installation device 136 comprises a plurality of pile connection assemblies 9 via which in use each foundation pile 211 is connected to the bridge assembly 7.

Each pile connection assembly 9 comprises a pile connector 15. Each pile connector 15 is configured to be connected to an upper part 205 of each foundation pile 211 which is to be moved into the ground or seabed 3.

At least a plurality of, but preferably all the pile connection assemblies 9 comprise an actuator 10 which extends downward from the respective connecting location. Each actuator 10 comprises an upper actuator part 11 and a lower actuator part 12. The upper actuator part 11 is connected to the bridge assembly 7. The lower actuator part 12 is connected to a corresponding pile connector 15.

The actuators 10 may be hydraulic actuators configured to extend and/or retract. The actuators 10 may also be rotating actuators 129. Also a combination of extending/retracting actuators 10 and rotating actuators 129 is possible. Rotating actuators 129 are required for installing helical piles 100, for example helical piles 100 according to the second aspect of the invention.

The bridge assembly 7 comprises a central opening 58 through which the at least one support pile 202 extends. The installation device 136 moves downward relative to the support pile 202 during installation of the foundation piles 211.

The bridge assembly 7 may comprise a plurality of guides 245 for guiding the movement of the installation device 136 relative to the support pile 202, wherein the guides extend into the central opening 58.

The guides may also be configured to engage the support pile 202 and to transfer a bending moment of the foundation piles 211 as a force into the support pile 202 via the bridge assembly 7.

The actuators 10 are rotating actuators 129, wherein the pile connector 15 comprising a male or female mating part 128 127 configured to mate with a corresponding mating part of a foundation pile 211. Here the male part is provided on the pile connector 15 as a sideways extending pin. The female part 227 is proved on the foundation pile 211 in the form of a slot.

The rotating actuators 129 can rotate both ways about a central axis thereof. In order to move in multiple piles at the same time, one half of the rotating actuators 129 may rotate in a clockwise 134 direction and the other half of the rotating actuators 129 may rotate in the counter clockwise 135 direction. This way the torque on the installation device 136 is balanced. The helical piles 100 then have corresponding clockwise 134 and counter clockwise 135 oriented helical sections, as shown in FIG. 41C.

The installation device 136 may also comprise an engaging member 247 configured to engage the support pile 202 and to exert a force on the support pile 202 in a vertical direction. Here the guide 245 is also the engaging member 247.

The lower part 206 of the support pile 202 can be moved into the ground or seabed 3 at least in part by a downward force exerted by the helical piles 100 on the foundation guides 207 or by pushing the installation device 136 connected to the foundation piles 211 upwards relative to the support pile 202.

During this process of pushing the support pile 202 further into the ground, levelling can be performed on the support pile 202 by pushing harder on one side than the other, via the foundation piles 211. This can be beneficial if installation tolerances are tight or to minimise/remove the use of a gripper frame or temporary installation template. The same levelling process can be done with push in piles and a device 1 according to the first aspect of the invention.

FIG. 42 shows an embodiment of the method wherein six foundation piles 211 are pushed into the ground by a device 1 according to the first aspect of the invention having the central opening 58. Said device 1 extends around the at least one support pile 202, wherein the at least one support pile 202 extends through the central opening 58. Here the support pile 202 does not extend into seabed 3, but rests on the seabed 3.

From left to right FIG. 42 shows the positioning of the support assembly 235 on the seabed 3. The installation device 1 is already connected to the foundation piles 211, but this may also occur after the positioning of the foundation piles 211. Next the foundation piles 211 are moved into the ground by pushing. The middle step shows the foundation piles 211 having reached their predetermined penetration depth. The fourth step is disconnecting the installation device 1. The right step shows the moving away of the installation device 1 from the support assembly 235, in particular by moving the installation device 136 upward relative to the support pile 202.

The foundation piles 211 may in general be moved into the ground or the seabed 3 by hammering, screwing, pushing, or a combination thereof.

The support assembly 235 may be installed in a vertical orientation. Also the foundation piles 211 may be moved into the ground or the seabed 3 vertically.

When a support assembly 235 comprising a support pile 202 with a suction bucket 234 is installed, as for example shown in the embodiment of FIG. 40, the lower part 206 can be moved into the ground or the seabed 3 at least in part via suction.

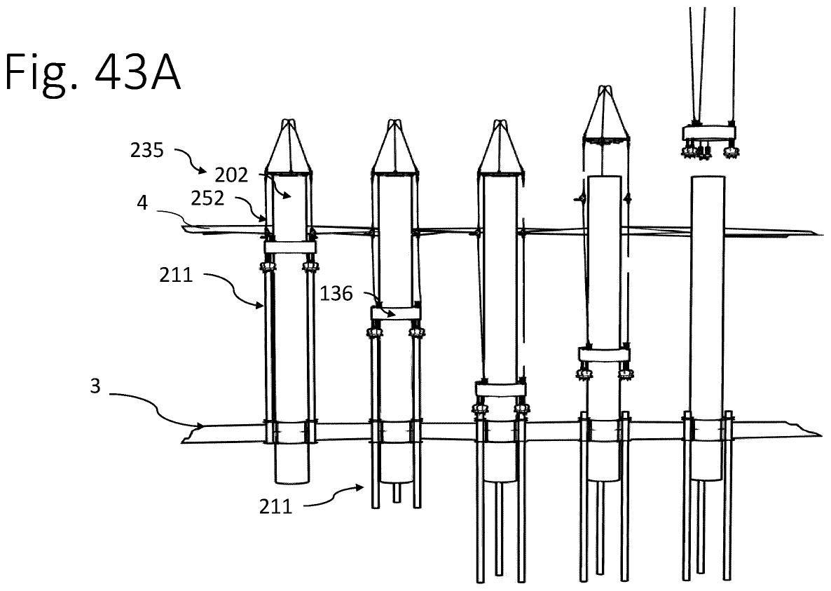

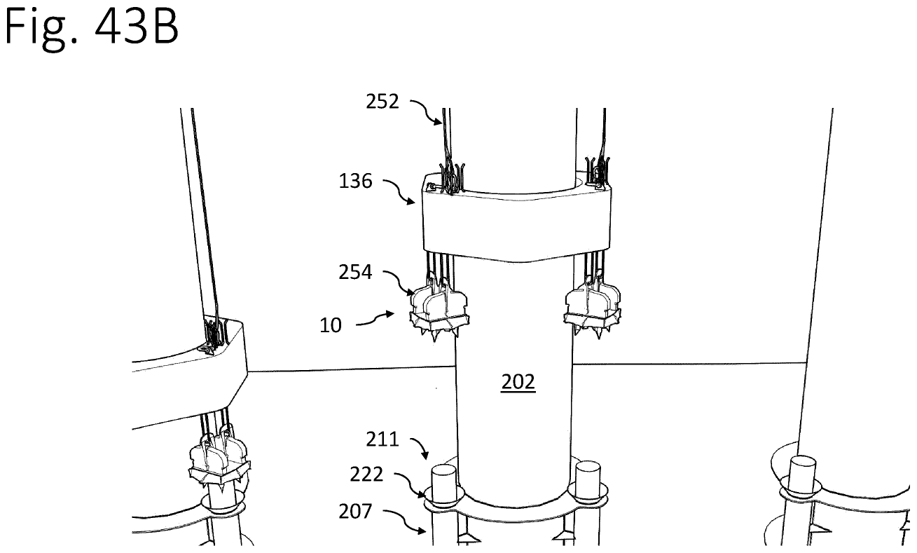

FIG. 43A shows an embodiment of the method for installing a support assembly 235 having three foundation piles 211 and one support pile 202. Here the foundation piles 211 are installed using installation device 136 comprising hammers, or vibro-hammers 254 as actuators 10, see FIG. 43B.

From left to right, the support pile 202 is first positioned on the seabed 3 and moved partly into the seabed 3. Next the foundation piles 211 are hammered into the seabed 3. In the middle the foundation piles 211 have reached their predetermined penetration depth. The fourth and fifth step show the disconnecting and moving away of the installation device 136, see also FIG. 43B.

After the foundation piles 211 are installed the orientation of the support pile 202 may be adjusted by moving the foundation piles 211 relative to the support pile 202 or by moving the support pile 202 relative to the foundation piles 211.

In a later step the foundation piles 211 are fixated to their respective foundation guide. This can be done in different ways, for example by grouting, swaging, or a combination thereof.

FIG. 44 shows an example of a swaging connection 228. The foundation pile 211 extends through the foundation guide 207, see the left cross-section of FIG. 44. On an inner side 226 of the foundation guide 207 at least one annular recess 225 is provided. Here this is achieved by providing annular rings 255 on the inner side 226 at a distance from each other. A swaging tool is inserted in the foundation pile 211 which increases the pressure in the part of the pile which is located in the foundation guide. Because of the pressure increase the wall 256 of the foundation pile 211 will be pushed in the at least one annular recess 225, as shown in the right cross-section of FIG. 44. This provides an effective fixation.

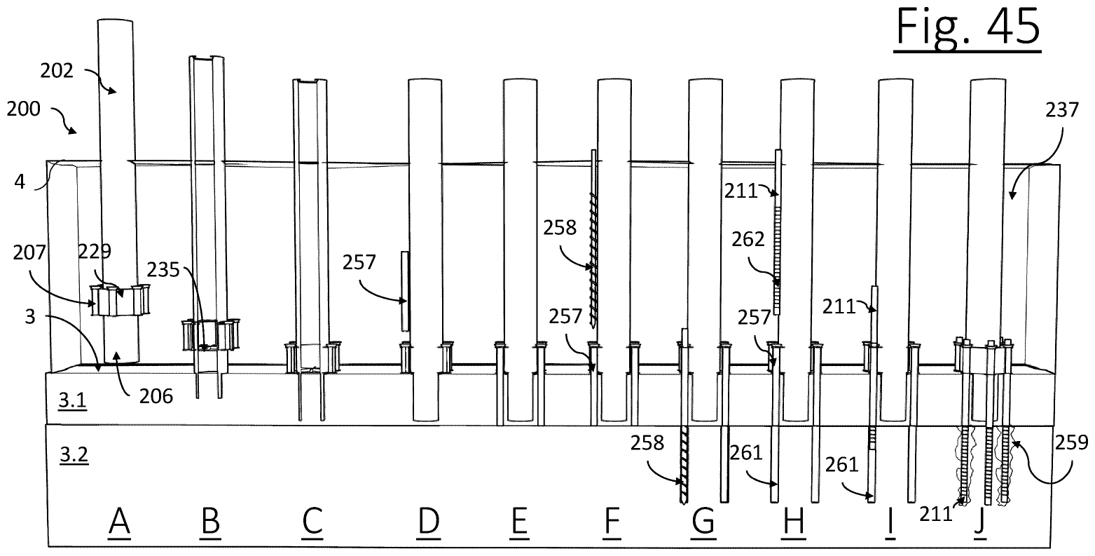

FIG. 45 shows another embodiment of a method of installing a support assembly 237 according to the invention into the ground or a seabed. The method as shown in FIG. 45 is in particular beneficial for more rocky soil 3.2. The method comprises the steps of positioning the support pile 202 with its bottom end on the ground or the seabed and moving a part of the lower part 206 of the support pile 202 into the ground or the seabed 3, and the steps of positioning the foundation piles 211 in the foundation guides 207 and moving the foundation piles 211 at least partly into the ground or the seabed 3 over the foundation depth 238.

The method is shown in steps A to J of FIG. 45. Step A shows the lowering of an embodiment of the support structure 200 according to the invention towards the seabed 3. A lower end of the foundation frame 229 is located a distance above the lower end of the support pile 202.

Step B shows a step of moving the lower part 206 of the support pile 202 into the seabed 3. This can for example be done by self-weight penetration, vibro-hammering the support pile, or via a suction bucket inside the lower part of the support pile.

Step C shows a step wherein the support pile 202 has reached its desired penetration depth. The foundation frame 229 and/or the foundation guides 207 have come to rest on the seabed.

Step D shows the lowering of a casing 257 to the foundation guides, wherein step E shows multiple casings 257, i.e. one for each foundation guide 207, extending through the foundation guides and into the soil, in particular up to the point where the casings 257 hit the more rocky ground layer 3.2. The casings may be installed via hammering, vibro-hammering or any other suitable installation method. The soil above the more rocky ground layer 3.2 is typically a sand or clay layer 3.1. The casings 257 are hollow tubes or pipes that allow for the insertion of a drill 258.

Step F shows said drill 258 which is lowered towards the casing 257. The drill 258 is shown schematically. Hence the drive for driving the drill is not shown. The drill 258 is subsequently inserted through the casing 257 and drills a hole 261 through the more rocky ground layer 3.2. Step G shows the step in which the drill has reached its final drilling depth. The final drilling depth is substantially equal to the final foundation depth for the foundation piles.

Once the drill 258 has been removed from the drilled hole 261 a foundation pile is inserted in the drilled hole. This is shown in steps H and I. The foundation pile 211 may have grout ridges 262 that project outwards from the outer surface of the pile. The grout ridges 262 are shown as horizontal lines in FIG. 45.

Step J shows the step of grouting the foundation piles. Grout 259 is provided between one or more of the foundation piles 211 and the surrounding soil 3.2. Grout 259 may also be provided between one or more of the foundation piles 211 and their respective foundation guides 207 or casings 257.

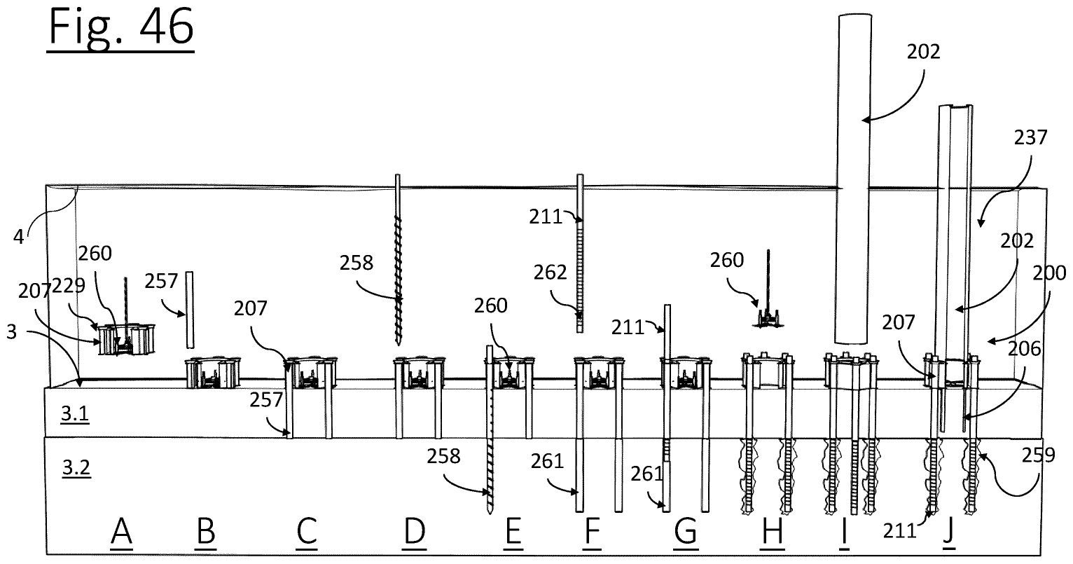

FIG. 46 shows yet another embodiment of a method of installing a support assembly 237 according to the invention into the ground or a seabed 3. The method comprises the steps of positioning the support pile 202 with its bottom end on the ground or the seabed and moving a part of the lower part 206 of the support pile 202 into the ground or the seabed 3. Further steps are positioning the foundation piles 211 in the foundation guides 207 and moving the foundation piles 211 at least partly into the ground or the seabed over the foundation depth.

The method is shown in steps A to J of FIG. 46. A difference with the other embodiments of the method according to the invention is that the support pile 202 and the foundation guides 207 of the support structure 200 are connected to each other in a later stage, in particular in a final stage of the installation instead of prior to installation.

Step A shows the lowering of the foundation guides 207 to the seabed 3. The foundation guides 207 are connected to a lowering template 260 for lowering the foundation guides and foundation frame 229 to the seabed. The lowering template may be connected to the crane on board of an installation vessel. The lowering template 260 allows for a controlled set down of the foundation frame and guides and is removed after the foundation frame is installed.

When the foundation guides 207 are positioned on the seabed, as shown in step B, casings 257 may be inserted through the foundation guides. This may be the case when the foundation piles are to be provided through a more rocky ground layer 3.2. In case the foundation piles only have to extend through a softer ground layer, e.g. a sand or clay layer 3.1, the casings may be omitted, because the foundation piles may be driven directly into the soil without pre-drilling holes. For installation of the support assembly in a softer ground layer steps B to F may therefore be omitted. Also the grouting between the foundation piles and the soil in steps H to J may be omitted.

Step C shows multiple casings 257, i.e. one for each foundation guide 207, extending through the foundation guides and into the soil 3.1, in particular up to the point where the casings hit the more rocky ground layer 3.2.

Step D shows a drill 258 which is lowered towards the casing 257. The drill is subsequently inserted through the casing 257 and drills a hole 261 through the more rocky ground layer 3.2. Step E shows the step in which the drill has reached its final drilling depth. The final drilling depth is substantially equal to the final foundation depth for the foundation piles.

Once the drill has been removed from the drilled hole 261 a foundation pile 211 is inserted in the drilled hole. This is shown in steps F and G. The foundation pile may have grout ridges 262 that project outwards from the outer surface of the pile. The grout ridges 262 are shown as horizontal lines.

Step H shows the grouting step, wherein grout 259 is provided between one or more of the foundation piles 211 and the surrounding soil 3.2. Also one or more of the foundation piles 211 may be grouted to their respective foundation guides 207 or casings 257. The casings 257 may be grouted to the foundation guides 207. Step H shows the removal of the lowering template 260. The removal is typically done after grouting and by lifting the template with the onboard crane.

Step I shows the lowering of the support pile 202 towards the foundation guides 207. The support pile 202 is inserted between the foundation guides 207 and subsequently moved into the seabed 3. The support pile may be moved into the seabed by hammering, vibro-hammering, a suction bucket 235 or any other suitable installation method. An advantage of this embodiment is that the support pile is not yet connected to the foundation guides so that hammering does not have a negative effect on the structure of the foundation guides.

Step J shows the support pile 202 after it has reached its final penetration depth. The support pile 202 may be provided with stopper members (not shown) that extend from the outer surface of the support pile 202. The stopper members, for example brackets in the form of inverted consoles, are configured to rest on the foundation frame 229. This way the penetration depth of the support pile may be controlled while the stopper members provide extra support between the support pile and the foundation guides and piles when installed. After reaching its final penetration depth the support pile 202 may be grouted to the foundation guides, here the foundation frame.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising i.e., open language, not excluding other elements or steps.

Any reference signs in the claims should not be construed as limiting the scope of the claims or the invention. It will be recognized that a specific embodiment as claimed may not achieve all of the stated objects.

The mere fact that certain measures are recited in mutually different dependent claims does not indicate that a combination of these measures cannot be used to advantage.

White lines between text paragraphs in the text above indicate that the technical features presented in the paragraph may be considered independent from technical features discussed in a preceding paragraph or in a subsequent paragraph.

1-142. (canceled)

143. A support structure for supporting a top structure, in particular a wind turbine, above the ground or a seabed, the support structure comprising:
one single support pile having a length and a first outer diameter, the one single support pile comprising:
an upper part configured and intended to extend above the ground or the seabed, wherein the upper part of the support pile is configured to be connected to the top structure, and
a lower part configured to be in contact with the ground or seabed,
wherein the support pile is configured to exert an upward vertical force on the top structure in order to carry the top structure, and
a plurality of foundation guides connected to the lower part of the single support pile, each foundation guide having an opening extending in a direction of the support pile, the opening having an opening diameter, wherein each foundation guide is configured to accommodate a foundation pile, wherein the foundation pile is configured to extend through the foundation guide and at least partly into the ground or the seabed, wherein the foundation guides are configured to receive a vertical force from the foundation piles.

144. A support structure for supporting a top structure above the ground or a seabed, the support structure comprising:
one single support pile having a length and a first outer diameter, the support pile comprising:
an upper part configured and intended to extend above the ground or the seabed, wherein the upper part of the support pile is configured to be connected to the top structure, and
a lower part, wherein at least a bottom part of the lower part is configured and intended to extend into the ground or the seabed, and
a plurality of foundation guides connected to the lower part of the support pile, each foundation guide having an opening extending in a direction of the support pile, the opening having an opening diameter, wherein each foundation guide is configured to accommodate a foundation pile, wherein the foundation pile is configured to extend through the foundation guide and at least partly into the ground or the seabed.

145. The support structure according to claim 144, wherein the foundation guides are provided at a distance above a bottom end of the support pile.

146. The support structure according to claim 144, wherein a longitudinal axis of the opening of the foundation guides extends parallel to a central axis of the support pile.

147. The support structure according to claim 144, wherein in top view the foundation guides are arranged around the support pile.

148. The support structure according to claim 144, wherein the support pile comprises a widening part extending over a distance upwards from the lower end, the widening part having a second outer diameter which is greater than the first outer diameter, wherein in top view the foundation guides extend outside the first outer diameter and inside the widening part having the second outer diameter.

149. The support structure according to claim 144, wherein a length of the foundation guide is at least twice the opening diameter of the opening of the foundation guide.

150. The support structure according to claim 144, comprising at least three foundation guides.

151. The support structure according to claim 144, wherein the foundation guides are connected to each other via a foundation frame, the foundation frame being connected to and extending around the support pile for providing stiffness to the connection between the foundation guides and the support pile.

152. The support structure according to claim 144, wherein a bottom end of the foundation guide is configured and intended to rest on the ground or the seabed.

153. The support structure according to claim 144, wherein the opening diameter of the foundation guides is smaller than the first outer diameter, in particular at least 3 times smaller.

154. The support structure according to claim 144, wherein the lower part of the support pile is configured to extend into the ground or seabed by a distance of at least one time the first outer diameter of the support pile.

155. The support structure according to claim 144, wherein a suction bucket is provided inside the lower part of the support pile for moving the lower part of the support pile into the ground or the seabed via suction.

156. A support assembly for supporting a top structure above the ground or a seabed, the support assembly comprising:
a support structure according to claim 144, and
a plurality of foundation piles, wherein each foundation pile extends through a respective foundation guide and is configured and intended to extend at least partly into the ground or the seabed over a foundation depth for providing resistance against overturning of the support pile.

157. The support assembly according to claim 156, wherein the top structure is a wind turbine.

158. The support assembly according to claim 156, wherein the foundation pile comprises at least one helix at a lower end thereof extending around the outer surface, wherein the foundation pile is configured to be rotated about its longitudinal axis during installation into the ground or the seabed.

159. A method for installing the support assembly according to claim 156 into the ground or a seabed, the method comprising the steps of:
positioning the single support pile with its bottom end on the ground or the seabed and moving a part of the lower part of the support pile into the ground or the seabed, and
positioning the foundation piles in the foundation guides and moving the foundation piles at least partly into the ground or the seabed over the foundation depth.

160. The method according to claim 159, wherein the foundation guides and foundation piles are installed first, wherein after the foundation guides and foundation piles are installed the support pile is lowered to the seabed and installed.

161. The method according to claim 159, wherein the foundation piles are moved into the ground or the seabed by an installation device, wherein the installation device comprises:
a bridge assembly which when seen in top view defines a plurality of connecting locations corresponding to the plurality of foundation piles, and
a plurality of pile connection assemblies via which in use each foundation pile is connected to the bridge assembly, wherein each pile connection assembly comprises:
a pile connector wherein each pile connector is configured to be connected to an upper part of each foundation pile which is to be moved into the ground or seabed,
wherein at least a plurality of the pile connection assemblies comprise an actuator which extends downward from the respective connecting location, wherein each actuator comprises an upper actuator part and a lower actuator part, wherein the upper actuator part is connected to the bridge assembly, wherein the lower actuator part is connected to a corresponding pile connector.

162. The method according to claim 161, wherein the bridge assembly comprises a central opening through which the support pile extends, and wherein the installation device moves downward relative to the support pile during installation of the foundation piles.

163. The method according to claim 159, wherein the foundation piles extend through the foundation guides during the lowering and positioning of the support assembly.
